(19) United States
(12) Patent Application Publication
(10) Pub. No.: US 2017/0235799 A1
(43) Pub. Date: Aug. 17, 2017

(54) SYSTEMS AND METHODS FOR SEARCHING DATABASES USING GRAPHICAL USER INTERFACES THAT INCLUDE CONCEPT STACKS

(71) Applicant: LexisNexis, a division of Reed Elsevier Inc., Miamisburg, OH (US)

(72) Inventors: Richard D. Miller, Yellow Springs, OH (US); Jacob Aaron Myers, Dayton, OH (US); Gaurav Mehra, Mason, OH (US); Todd J. Frascone, Donnelsville, OH (US); Jordan Jalles, San Jose, CA (US)

(73) Assignee: LexisNexis, a division of Reed Elsevier Inc., Miamisburg, OH (US)

(21) Appl. No.: 15/041,137

(22) Filed: Feb. 11, 2016

(51) Int. Cl. G06F 17/30

(52) U.S. Cl. CPC G06F 17/30554; G06F 17/30477; G06F 17/30498

(57) ABSTRACT

Systems and methods for searching databases using graphical user interfaces that include concept stacks are disclosed. A method includes providing for display graphical user interface comprising a query building canvas. The graphical user interface includes concept stacks that include stacked concept nodes associated with query terms that are joined with Boolean ORs. The concept stacks are connected by a conjunctive proximity connector that joins the query expressions associated with each concept stack. The graphical user interface includes a connector node that includes a graphical indication of the conjunctive proximity connector. The method further includes generating a search query to include query expressions associated with the concept stacks that are connected by the conjunctive proximity connector. The method further includes searching the database using the search query to identify the result set of documents.

### BACKGROUND

Field

The present specification generally relates to searching databases using graphical user interfaces and, more particularly, to systems and methods for searching databases using graphical user interfaces that include concept stacks.

Technical Background

Users utilize computers to construct search queries to search computerized document databases (e.g., legal document databases, patent document databases, news article document databases, financial document databases, etc.) in order to identify documents that satisfy a search objective. However, it may be a time consuming and difficult endeavor to utilize some existing graphical user interfaces presented on a computer display device that are provided to search computerized document databases. Furthermore, it may be desirable to visualize and manipulate a search query on a graphical user interface in an intuitive and user friendly manner.

Accordingly, a need exists for systems and methods for searching databases using graphical user interfaces that include concept stacks.

### SUMMARY

In one embodiment, a method for searching a database to identify a result set of documents includes providing for display, automatically by a computer, a graphical user interface comprising a query building canvas. The method further includes receiving a first user input indicative of a first query term and providing for display a first concept node in the query building canvas. The first concept node includes a first graphical indication of the first query term. The method further includes receiving a second user input indicative of a second query term to be connected with a Boolean OR to the first query term in a first query expression of a search query. The method further includes providing for display a second concept node in the query building canvas. The second concept node includes a second graphical indication of the second query term. The first concept node and the second concept node are stacked relative to one another in a first concept stack. The method further includes receiving a user input indicative of a conjunctive proximity connector for connecting the first query expression to a second query expression in the search query. The method further includes providing for display a connector node in the query building canvas such that the connector node is adjacent to the first concept stack. The connector node includes a graphical indication of the conjunctive proximity connector. The method further includes receiving a third user input indicative of a third query term and providing for display a third concept node in the query building canvas. The third concept node includes a third graphical indication of the third query term. The third concept node is adjacent to the connector node and the connector node is disposed between the third concept node and the first concept stack. The method further includes receiving a fourth user input indicative of a fourth query term to be connected with a Boolean OR to the third query term in the second query expression of the search query, and providing for display a fourth concept node in the query building canvas. The fourth concept node includes a fourth graphical indication of the fourth query term. The third concept node and the fourth concept node are stacked relative to one another in a second concept stack. The method further includes generating the search query to include the first query expression, the second query expression, and the connector. The first query expression includes the first query term connected to the second query term with a Boolean OR, the second query expression includes the third query term connected to the fourth query term with a Boolean OR, and the first query expression and the second query expression are connected by the conjunctive proximity connector. The method further includes searching the database using the search query to identify the result set of documents, wherein the result set of documents are identified based on the search query.

In another embodiment, a method for searching a database to identify a result set of documents includes providing for display, automatically by a computer, a graphical user interface comprising a query building canvas and providing for display a first concept node in the query building canvas. The method further includes receiving a first user input indicative of a first query term to associate with the first concept node after providing for display the first concept node. The method further includes providing for display a first graphical indication of the first query term in the first concept node in response to receiving the first user input. The method further includes providing for display a second concept node in the query building canvas such that the first concept node and the second concept node are stacked relative to one another in a first concept stack. The method further includes receiving a second user input indicative of a second query term to be associated with the second concept node and to be connected with a Boolean OR to the first query term in a first query expression of a search query, after providing for display the second concept node. The method further includes providing for display a second graphical indication of the second query term in the second concept node in response to receiving the second user input. The method further includes receiving a user input indicative of a conjunctive proximity connector for connecting the first query expression to a second query expression in the search query, and providing for display a connector node in the query building canvas such that the connector node is adjacent to the first concept stack. The connector node includes a graphical indication of the conjunctive proximity connector. The method further includes providing for display a third concept node in the query building canvas such that the third concept node is adjacent to the connector node and the connector node is disposed between the third concept node and the first concept stack. The method further includes, after providing for display the third concept node, receiving a third user input indicative of a third query term to be associated with the third concept node. The method further includes providing for display a third graphical indication of the third query term in the third concept node in response to receiving the third user input. The method further includes providing for display a fourth concept node in the query building canvas such that the third concept node and the fourth concept node are stacked relative to one another in a second concept stack. The method further includes, after providing for display the fourth concept node, receiving a fourth user input indicative of a fourth query term to be associated with the fourth concept node and to be connected with a Boolean OR to the third query term in the second query expression of the search query. The method further includes providing for display a fourth graphical indication of the fourth query term in the fourth concept node in response to receiving the fourth user input. The method further includes generating the search query to include the first query expression, the second query expression, and the conjunctive proximity connector. The first query expression includes the first query term connected to the second query term with a Boolean OR. The second query expression includes the third query term connected to the fourth query term with a Boolean OR. The first query expression and the second query expression are connected by the conjunctive proximity connector. The method further includes searching the database using the search query to identify the result set of documents, wherein the result set of documents are identified based on the search query.

In yet another embodiment, a method for searching a database to identify a result set of documents includes providing for display, automatically by a computer, a graphical user interface comprising a query building canvas. The method further includes receiving user input indicative of: a first plurality of query terms to be connected with Boolean ORs in a first query expression of a search query, a second plurality of query terms to be connected with Boolean ORs in a second query expression of the search query, and a conjunctive proximity connector for connecting the first query expression to the second query expression in the search query. The method further includes providing for display a first concept stack in the query building canvas, wherein the first concept stack includes a first plurality of concept nodes stacked relative to on one another. Individual concept nodes of the first plurality of concept nodes correspond to individual query terms of the first plurality of query terms. Individual concept nodes of the first plurality of concept nodes include graphical representations of the corresponding individual query terms of the first plurality of query terms. The method further includes providing for display a connector node in the query building canvas such that the connector node is adjacent to the first concept stack. The connector node comprises a graphical indication of the conjunctive proximity connector. The method further includes providing for display a second concept stack in the query building canvas adjacent to the connector node such that the connector node is disposed between the first concept stack and the second concept stack. The second concept stack includes a second plurality of concept nodes stacked relative to one another. Individual concept nodes of the second plurality of concept nodes correspond to individual query terms of the second plurality of query terms. Individual concept nodes of the second plurality of concept nodes include graphical representations of the corresponding individual query terms of the second plurality of query terms. The method further includes generating the search query to include the first query expression, the second query expression, and the conjunctive proximity connector. The first query expression includes the first plurality of query terms connected with the Boolean Ors. The second query expression includes the second plurality of query terms connected with the Boolean Ors. The first query expression and the second query expression are connected by the conjunctive proximity connector. The method further includes searching the database using the search query to identify the result set of documents, wherein the result set of documents are identified based on the search query.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 depicts a schematic illustration of a computing network for a system for performing the functions described herein, according to one or more embodiments shown and described herein;

FIG. 2 depicts a schematic illustration of the server computing device from FIG. 1, further illustrating hardware and software that may be utilized to perform the functions described herein, according to one or more embodiments shown and described herein;

FIG. 3 depicts a schematic illustration of a graphical user interface that includes a concept node, according to one or more embodiments show and described herein;

FIG. 4 depicts a schematic illustration of a graphical user interface that includes a concept node that includes a graphical indication of a user provided query term, according to one or more embodiments show and described herein;

FIG. 5 depicts a schematic illustration of a graphical user interface that includes two concept stacks and a conjunctive proximity connector disposed between the concept stacks, wherein each concept stack includes a concept node, according to one or more embodiments show and described herein;

FIG. 6 depicts a schematic illustration of a graphical user interface that includes two concept stacks, wherein the first concept stack includes one concept node and the second concept stack includes two concept nodes, according to one or more embodiments show and described herein;

FIG. 7 depicts a schematic illustration of a graphical user interface that includes three concept stacks and two conjunctive proximity connectors, according to one or more embodiments show and described herein;

FIG. 8 depicts a schematic illustration of a graphical user interface that includes three concept stacks and two conjunctive proximity connectors, according to one or more embodiments show and described herein;

FIG. 9 depicts a schematic illustration of a graphical user interface that includes three concept stacks and two conjunctive proximity connectors, according to one or more embodiments show and described herein;

FIG. 10 depicts a schematic illustration of a graphical user interface that includes three concept stacks, two conjunctive proximity connectors, and a suggested query term drop box, according to one or more embodiments show and described herein;

FIG. 11 depicts a schematic illustration of a graphical user interface displaying a results display portion, according to one or more embodiments shown and described herein;

FIG. 12 depicts a schematic illustration of a graphical user interface displaying a results display portion, according to one or more embodiments shown and described herein;

FIG. 13 depicts a schematic illustration of a graphical user interface displaying a results display portion, according to one or more embodiments shown and described herein; and

FIG. 14 depicts a schematic illustration of a graphical user interface displaying a results display portion, according to one or more embodiments shown and described herein.

### DETAILED DESCRIPTION

Referring generally to the figures, embodiments described herein are directed to systems and methods for searching databases using graphical user interfaces that include concept stacks. The graphical user interfaces described herein include concept stacks that include stacked concept nodes associated with query terms that are joined with Boolean ORs. The concept stacks are connected by conjunctive proximity connectors that join the query expressions associated with each concept stack. The graphical user interfaces described herein may facilitate the generation of search queries by allowing a user to construct the search queries with the query building canvases described herein. The graphical user interfaces described herein may also allow a user to iteratively refine and manipulate search queries by interacting with the graphical user interfaces. The graphical user interfaces described herein may also allows a user to understand the quality of a query and/or the results generated by a query in an intuitive and user-friendly manner such that a user may identify desired content and have confidence that the identified content is relevant. Various embodiments of systems and methods for searching databases using graphical user interfaces that include concept stacks are described below.

Although the embodiments are described herein in the context of a document database including legal documents (e.g., cases, statutes, etc.), patent documents, news documents, financial documents, and the like, it should be understood that embodiments are not limited thereto.

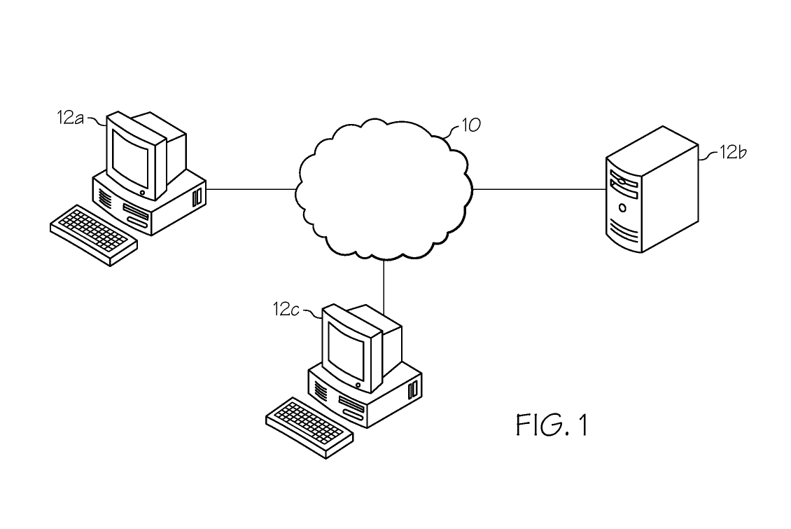

Referring now to the drawings, FIG. 1 depicts an exemplary computing network, illustrating components for a system for performing the functions described herein, according to embodiments shown and described herein. As illustrated in FIG. 1, a computer network 10 may include a wide area network, such as the internet, a local area network (LAN), a mobile communications network, a public service telephone network (PSTN) and/or other network and may be configured to electronically connect a user computing device 12a, a server computing device 12b, and an administrator computing device 12c.

The user computing device 12a may be used to facilitate searching of a document database. In particular, the user computing device 12a may display a graphical user interface to a user that allows the user to provide input to construct a search query for searching the document database, as will be described in further detail below. The user computing device 12a may also display a result set of documents and information pertaining to the result set of documents, such as a qualify feedback score as described below. The user computing device 12a may also be utilized to perform other user functions.

The administrator computing device 12c may, among other things, perform administrative functions for the server computing device 12b. In the event that the server computing device 12b requires oversight, updating, or correction, the administrator computing device 12c may be configured to provide the desired oversight, updating, and/or correction. The administrator computing device 12c, as well as any other computing device coupled to the computer network 10, may be used to input one or more documents into the document database. Some embodiments do not include the administrator computing device 12c.

The server computing device 12b may provide for display graphical user interfaces, which may be displayed on the user computing device 12a. The graphical user interfaces may be manipulated by a user in order to provide user input that is received by the server computing device 12b and aggregated into a search query used to search the document database. The server computing device 12b may construct the search query based on the user input received from the user computing device 12a. The server computing device may search a document database using the search query to identify a result set of documents. The server computing device 12b may also transmit information to the user computing device 12a such that the user computing device 12a may display the result set of documents and information pertaining to the result set of documents. The components and functionality of the server computing device 12b will be set forth in detail below.

It should be understood that while the user computing device 12a and the administrator computing device 12c are depicted as personal computers and the server computing device 12b is depicted as a server, these are nonlimiting examples. More specifically, in some embodiments any type of computing device (e.g., mobile computing device, tablet computing device, smartphone, personal computer, server, etc.) may be utilized for any of these components. Additionally, while each of these computing devices is illustrated in FIG. 1 as a single piece of hardware, this is also merely an example. More specifically, each of the user computing device 12a, server computing device 12b, and administrator computing device 12c may represent a plurality of computers, servers, databases, etc.

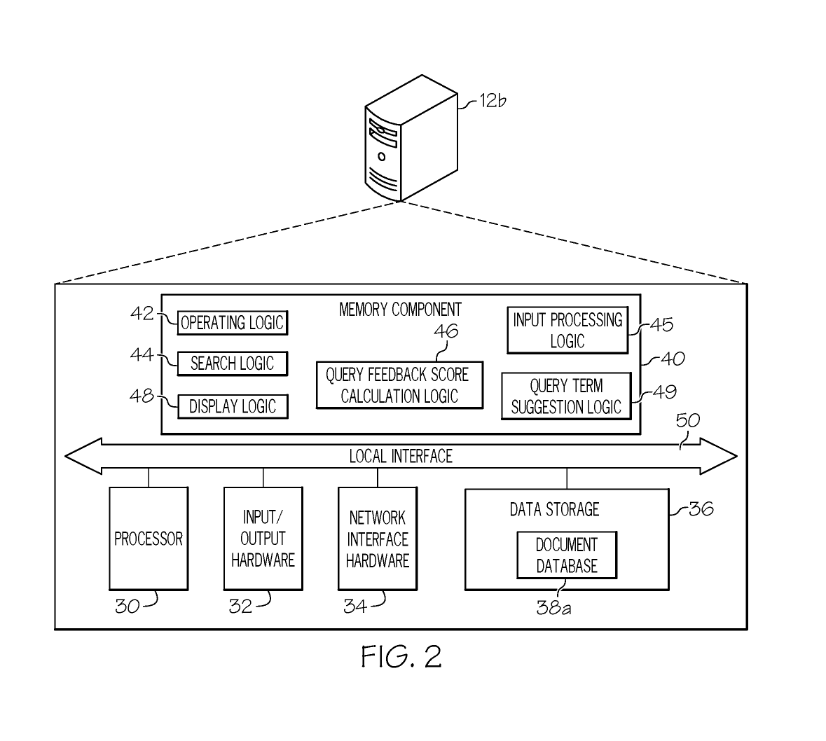

FIG. 2 depicts additional details regarding the server computing device 12b from FIG. 1. While in some embodiments, the server computing device 12b may be configured as a general purpose computer with the requisite hardware, software, and/or firmware, in some embodiments, that server computing device 12b may be configured as a special purpose computer designed specifically for performing the functionality described herein.

As also illustrated in FIG. 2, the server computing device 12b may include a processor 30, input/output hardware 32, network interface hardware 34, a data storage component 36 (which may store a document database 38a), and a non-transitory memory component 40. The memory component 40 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 40 may be configured to store operating logic 42, search logic 44, input processing logic 45, query feedback score calculation logic 46, display logic 48, and query term suggestion logic 49 (each of which may be embodied as a computer program, firmware, or hardware, as an example). A local interface 50 is also included in FIG. 2 and may be implemented as a bus or other interface to facilitate communication among the components of the server computing device 12b.

The processor 30 may include any processing component configured to receive and execute instructions (such as from the data storage component 36 and/or memory component 40). The input/output hardware 32 may include a monitor, keyboard, mouse, printer, camera, microphone, speaker, touchscreen, and/or other device for receiving, sending, and/or presenting data. In some embodiments, the user may interact with the user interfaces provided herein via voice to provide the user with a natural interaction experience, which may be useful in some embodiments in which the user computing device 12a is a tablet or smartphone. In embodiments in which the search query is input via voice, the voice input may be translated, parsed, or processed in some manner by a speech recognition algorithm to produce the search query. The network interface hardware 34 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 36 may reside local to and/or remote from the server computing device 12b and may be configured to store one or more pieces of data for access by the server computing device 12b and/or other components. As illustrated in FIG. 2, the data storage component 36 may store the document database 38a, which in at least one embodiment includes documents that have been organized and indexed for searching. The document database 38a may be stored in one or more data storage devices. In another embodiment, the server computing device 12b may be coupled to a remote server or data storage device that comprises one or more of the documents in the document database 38a. Other data may be stored in the data storage component 36 to provide support for functionalities described herein.

Included in the memory component 40 are the operating logic 42, the search logic 44, the input processing logic 45, the query feedback score calculation logic 46, the display logic 48, and the query term suggestion logic 49. The operating logic 42 may include an operating system and/or other software for managing components of the server computing device 12b. The input processing logic 45 may reside in the memory component 40 and may be configured to receive user input transmitted to the server computing device 12b from the user computing device 12a, and process the received user input, such as by constructing a search query based on the user input. Similarly, the search logic 44 may reside in the memory component 40 and may be configured to search the document database 38a with search queries. The query feedback score calculation logic 46 may be operable to calculate a query feedback score for a search query used to search the document database 38a in order to return a result set of documents. The display logic 48 may provide for display the graphical user interfaces described herein to the user computing device 12a, such that the user computing device 12a may display the graphical user interfaces and allow a user of the user computing device 12a to provide user input. The display logic 48 may also provide for display the result set of documents and information pertaining to the result set of documents, as described further below. The display logic 48 may provide for display the graphical user interfaces and other displayed items described herein by transmitting information to the user computing device 12a, such that the user computing device 12a may display the graphical user interfaces and other displayed items to the user. The query term suggestion logic 49 may generate a query term suggestion that is transmitted to the user computing device 12a for display to a user. The functionalities of the operating logic 42, the search logic 44, the input processing logic 45, the query feedback score calculation logic 46, the display logic 48, and the query term suggestion logic 49 will be described in further detail below.

It should be understood that the components illustrated in FIG. 2 are merely exemplary and are not intended to limit the scope of this disclosure. More specifically, while the components in FIG. 2 are illustrated as residing within the server computing device 12b, this is a nonlimiting example. In some embodiments, one or more of the components may reside external to the server computing device 12b. Similarly, while FIG. 2 is directed to the server computing device 12b, other components such as the user computing device 12a and the administrator computing device 12c may include similar hardware, software, and/or firmware.

Methods of providing for display graphical user interfaces, receiving user input in response to the displayed graphical user interfaces, generating search queries based on the received user input, and searching document databases based on the generated search queries will now be described with reference to the remaining figures. Although some of the steps associated with the methods described herein are described as being separate tasks, in other embodiments, the steps may be combined or omitted. Further, while the steps associated with the methods described herein may be described as being performed in a particular order, in other embodiments, the steps may be performed in a different order. Various graphical user interfaces provided for display in accordance with some embodiments are depicted in the following figures. It should be understood that embodiments are not limited to the configurations of the graphical user interfaces illustrated throughout the figures, and that other graphical user interface configurations are possible. In one embodiment, the computer network 10 is the Internet and the graphical user interfaces described herein are presented to the user on a display device of the user computing device 12a via a web browser.

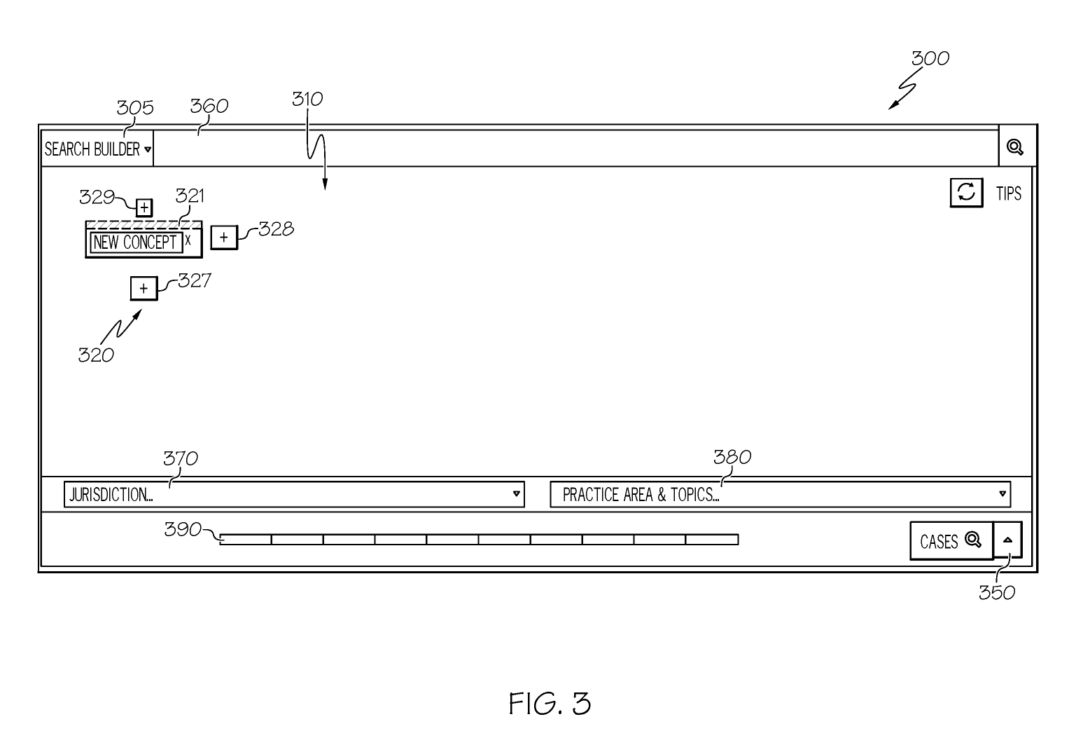

Referring now to FIG. 3, a graphical user interface 300 is schematically depicted. In some embodiments, the graphical user interface 300 is provided for display by the server computing device 12b. In some embodiments, the server computing device 12b transmits a message to the user computing device 12a that causes the user computing device 12a to display the provided graphical user interface 300 and the components thereof. The server computing device 12b may generate the message or information to be displayed with the display logic 48. The graphical user interfaces described herein may facilitate the generation of search queries by allowing a user to construct the search queries with the query building canvases described herein. The graphical user interfaces described herein may also allow a user to iteratively refine and manipulate search queries by interacting with the graphical user interfaces. The graphical user interfaces described herein may also allows a user to understand the quality of a query and/or the results generated by a query in an intuitive and user-friendly manner such that a user may identify desired content and have confidence that the identified content is relevant. The graphical user interfaces described herein may be particularly useful when the user computing device 12a is a tablet device or smartphone. Furthermore, it should be understood that any of the graphical user interfaces and elements described herein may be embedded or integrated in various product features and at various points of a search process.

Referring to FIG. 3, the graphical user interface 300 includes a search builder button 305, a textual query translation portion 360, a query building canvas 310, a content type selection element 350, a jurisdiction selection element 370, a practice area selection element 380, and a query feedback indicator 390. Each of the search builder button 305, the textual query translation portion 360, the query building canvas 310, the content type selection element 350, the jurisdiction selection element 370, and the practice area selection element 380 may be provided for display by the server computing device 12b (e.g., by the display logic 48) and displayed by the user computing device 12a.

Still referring to FIG. 3, in some embodiments, the query building canvas 310, the content type selection element 350, the jurisdiction selection element 370, and the practice area selection element 380 may be displayed in response to a user manipulating (e.g., clicking on or otherwise selecting) the search builder button 305. For example, in some embodiments, the query building canvas 310, the content type selection element 350, the jurisdiction selection element 370, and the practice area selection element 380 may not be initially displayed until a user manipulates the search builder button 305, though in other embodiments these components may be displayed without requiring a user to manipulate the search builder button 305 in order to begin constructing a search query in the query building canvas 310.

Still referring to FIG. 3, the query building canvas 310 allows a user to graphically construct a query used to search a database of documents by adding concept nodes to concept stacks and joining adjacent concept stacks with conjunctive proximity connectors, as will be described further below. Each concept stack includes one or more concept nodes, each of which is associated with a query term (i.e., a word to be included in a search query or a phrase to be included in a search query). All of the query terms corresponding to the concept nodes in a concept stack are joined with a Boolean OR to form a query expression that is included in a search query used to search the database of documents. The query expressions associated with adjacent concept stacks are joined by conjunctive proximity connectors in the search query used to search the database of documents. The graphical construction of a query used to search the database of documents will be described with reference to the following figures, which describe a user adding a number of concept stacks comprised of one or more concept nodes to the query building canvas 310.

Still referring to FIG. 3, the query building canvas 310 includes a first concept stack 320 that is provided for display by the server computing device 12b (e.g., by the display logic 48) and displayed by the user computing device 12a. The first concept stack 320 includes a first concept node 321, an add concept node element 327, an add concept stack element 328, and a document segment selection element 329, each of which is provided for display by the server computing device 12b (e.g., by the display logic 48) and displayed by the user computing device 12a. The first concept node 321 includes highlighted text of “new concept,” which indicates to the user that the user may input a query term to be associated with the first concept node 321. In other embodiments, the first concept node 321 may not include text, may include different text or may be display text that is not highlighted.

Still referring to FIG. 3, the add concept node element 327 allows a user to add a concept node to the first concept stack 320 by manipulating the add concept node element 327. For example, in response to user manipulation of the add concept node element 327, a new concept node may be added to the first concept stack 320, such as when the new concept node is displayed beneath the first concept node 321. The add concept stack element 328 allows a user to add a new concept stack that is adjacent to the first concept stack 320, as will be described below. For example, in response to user manipulation of the add concept stack element 328, a new concept stack may be added adjacent to (e.g., to the right of) the first concept stack 320, and in some embodiments a connector node may be displayed between the first concept stack 320 and the newly added concept stack to indicate the conjunctive proximity connector that joins the one or more query terms in the first concept stack with the one or more query terms in the new concept stack, as will be described in further detail below.

The document segment selection element 329 may allow a user to limit the search of the query terms of the first concept stack 320 to a particular segment of the documents to be searched with the search query. For example, the document segment selection element 329 may allow a user to limit the search of the query terms of the first concept stack 320 to the abstract of a patent document, to the claims of a patent document, to the detailed description of a patent document, or the like. In some embodiments, in response to user manipulation of the document segment selection element 329, a plurality of document segment options, such as a drop down box including a variety of segments that may be selected may be provided for display by the server computing device 12b (e.g., by the display logic 48) and displayed by the user computing device 12a. The server computing device 12b may subsequently receive a selected document segment option of the plurality of document segment options, process the selected segment option with the input processing logic 45, and search the segment of documents in the database associated with the selected document segment option with the search query (e.g., by executing the search logic 44 of the server computing device 12b).

Still referring to FIG. 3, the textual query translation portion 360 displays a textual translation of a graphical query input into the query building canvas 310, as will be described further below. The jurisdiction selection element 370 allows a user to limit a search to documents from a particular jurisdiction, such as cases or other legal documents within a given state, court, circuit, or the like. The jurisdiction selection element 370 may also be manipulated by a user, such as by clicking on or otherwise selecting the jurisdiction selection element 370. In some embodiments, when a user clicks on or otherwise selects the jurisdiction selection element 370, a list of possible jurisdictions is displayed, and a user selects one of the displayed jurisdictions. In some embodiments, in response to user manipulation of the jurisdiction selection element 370, a plurality of jurisdiction options, such as a drop down box including a variety of jurisdictions that may be selected may be provided for display by the server computing device 12b and displayed by the user computing device 12a. The server computing device 12b may subsequently receive a selected jurisdiction option of the plurality of jurisdiction options, process the selected jurisdiction option with the input processing logic 45, and search the database to identify the result set of documents such that each document of the result set of documents is associated with the selected jurisdiction option (e.g., by executing the search logic 44 of the server computing device 12b).

Still referring to FIG. 3, the practice area selection element 380 allows a user to limit the search to documents associated with a particular practice group, such as document associated with torts, intellectual property, real property, criminal law, constitutional law, or the like. The practice area selection element 380 may also be manipulated by a user, such as by clicking on or otherwise selecting the practice area selection element 380. In some embodiments, when a user clicks on the practice area selection element 380, a list of possible practice areas is displayed, and a user selects one of the displayed practice areas. For example, in some embodiments, in response to user manipulation of the practice area selection element 380, the server computing device 12b provides for display a plurality of practice area options that are displayed by the user computing device 12a, the server computing device 12b receives and processes a selected practice area option of the plurality of practice area options with the input processing logic 45, and the database is searched with the search logic 44 to identify the result set of documents such that each document of the result set of documents is associated with the selected practice area option.

Still referring to FIG. 3, the content type selection element 350 allows a user to limit the search to documents of a particular content type, such as cases, statutes, articles, and the like. The content type selection element 350 may also be manipulated by a user, such as by clicking on or otherwise selecting the content type selection element 350. In some embodiments, when a user clicks on the content type selection element 350, a list of possible content types is displayed, and a user selects one of the displayed content types. For example, in some embodiments, in response to user manipulation of the content type selection element 350, the server computing device 12b provides for display a plurality of content type options that are displayed by the user computing device 12a, the server computing device 12b receives and processes a selected content type option of the plurality of content type options with the input processing logic 45, and the database is searched with the search logic 44 to identify the result set of documents such that each document of the result set of documents is associated with the selected content type option.

The query feedback indicator 390 provides a visual indication of at least one characteristic of a search query constructed in the query building canvas relative to a result set of documents identified by searching a document database with the search query. In the embodiment depicted in FIG. 3, the query feedback indicator 390 is a bar. The bar may be displayed to provide a visual indication of a characteristic of the search query, such as by varying the length of the bar such that the length of the bar is indicative of the characteristic. In some embodiments, a color of the query feedback indicator 390 is indicative of the characteristic of the query. In some embodiments, the query feedback indicator 390 displays a relative breadth of the query, such that a short bar is indicative of a broad query and a long bar is indicative of a narrow query. In some embodiments, the query feedback indicator 390 includes a textual indication of the breadth of the query, such as “broad” or “narrow.” Some embodiments may display a textual indication of a quality of the query, such as by displaying “poor,” “good,” “better,” “best,” or the like. In other embodiment, the query feedback indicator 390 may be different from the embodiment depicted in FIG. 3 and described herein, such as in embodiment in which the query feedback indicator 390 is a gauge, is depicted as a series of “subway stops,” each of which indicates a different level of a characteristic of the search query.

It should be understood that other embodiments may include more or fewer elements than depicted in FIG. 3, such that other query components may be added or removed by manipulation with a drop box or other user prompt.

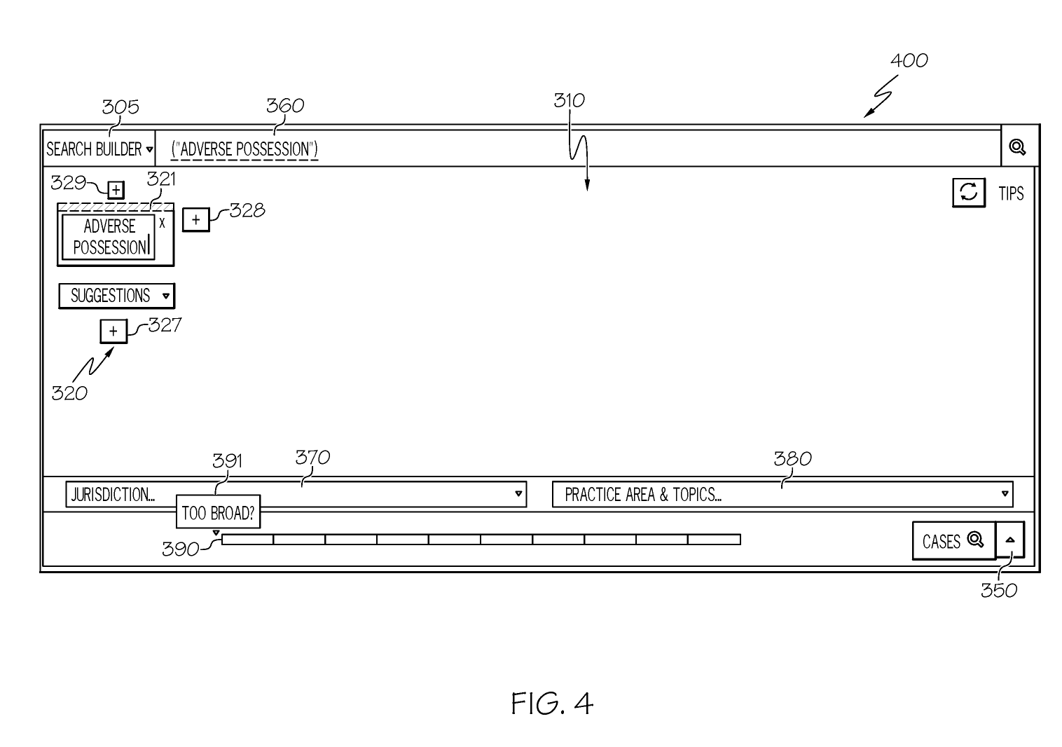

Referring now to FIG. 4, after displaying the graphical user interface 300 including the first concept node 321 as described above, a user may provide a first user input indicative of a first query term to be associated with the first concept node 321. In the embodiment depicted in FIG. 4, the user provides the query term “adverse possession” as the first user input. The input may be provided by the user via any input device, such as by a keyboard attached to the user computing device 12a, a touchscreen of the user computing device 12a, a microphone of the user computing device 12a, or the like. The server computing device 12b receives the first user input indicative of the first query term. In response to receiving the first user input indicative of the first query term, the server computing device 12b provides for display the first concept node 321 in the query building canvas 310 such that the first concept node 321 includes a graphical indication of the first query term. In the embodiment depicted in FIG. 4, the first graphical indication of the first query term is the text “adverse possession” though in other embodiments a graphical indication other than the text of the first query term may be displayed. In some embodiments, the first concept node 321 may not be displayed until after receiving the user input indicative of the first query term to be associated with the first concept node, such as embodiments in which a user may input the first query term via voice and the server computing device 12b may provide for display the first concept node 321 including the graphical indication of the first query term after receiving the voice input.

In response to receiving the first user input indicative of the first query term, the server computing device 12b generates a search query that includes the first query term “adverse possession” with the input processing logic 45 and then searches the database using the search query to identify a result set of documents based on the search query. The server computing device 12b may use the search logic 44 to search the document database 38a to identify a result set of document that are identified based on the search query. The search logic 44 may employ a search algorithm that identifies the result set of documents as the documents in the document database 38a that include one or more of the query terms of the search query and satisfy any additional constraints associated with the search query, such as content type, proximity of terms, or the like. A variety of search algorithms may be employed by the search logic 44. The server computing device 12b may use the query feedback score calculation logic 46 to calculate a query feedback score for the result set of documents. As noted above, the query feedback score is indicative of a characteristic of the search query relative to the identified result set of documents. The query feedback score may be calculated in any number of ways, such as based on the result set of documents and the search query. In some embodiments, the query feedback score is a function of the number of documents in the result set of documents. In some embodiments, the query feedback score is a function of the number of documents in the result set of documents and a number of concept nodes and/or concept stacks. In some embodiments, the query feedback score is an estimated relevance score, as described in U.S. patent application Ser. No. 14/267,340, entitled “SYSTEMS AND METHODS FOR DISPLAYING ESTIMATED RELEVANCE INDICATORS FOR RESULT SETS OF DOCUMENTS AND FOR DISPLAYING QUERY VISUALIZATIONS,” the entirety of which is incorporated by reference herein. In the embodiment depicted in FIG. 4, based on the calculated query feedback score, the server computing device 12b provides for display the query feedback indicator 390, which includes a textual indication 391 of “too broad” indicating that the search query was likely too broad based on the number of documents that were identified by the search. The server computing device 12b also provides for display a textual representation of the search query in the textual query translation portion 360, which is displayed by a display device of the user computing device 12a. The textual indication that the search query is “too broad” indicates that the user may wish to further restrict the search query before inspecting the result set of documents so that the result set of documents will likely be more relevant and helpful to the user.

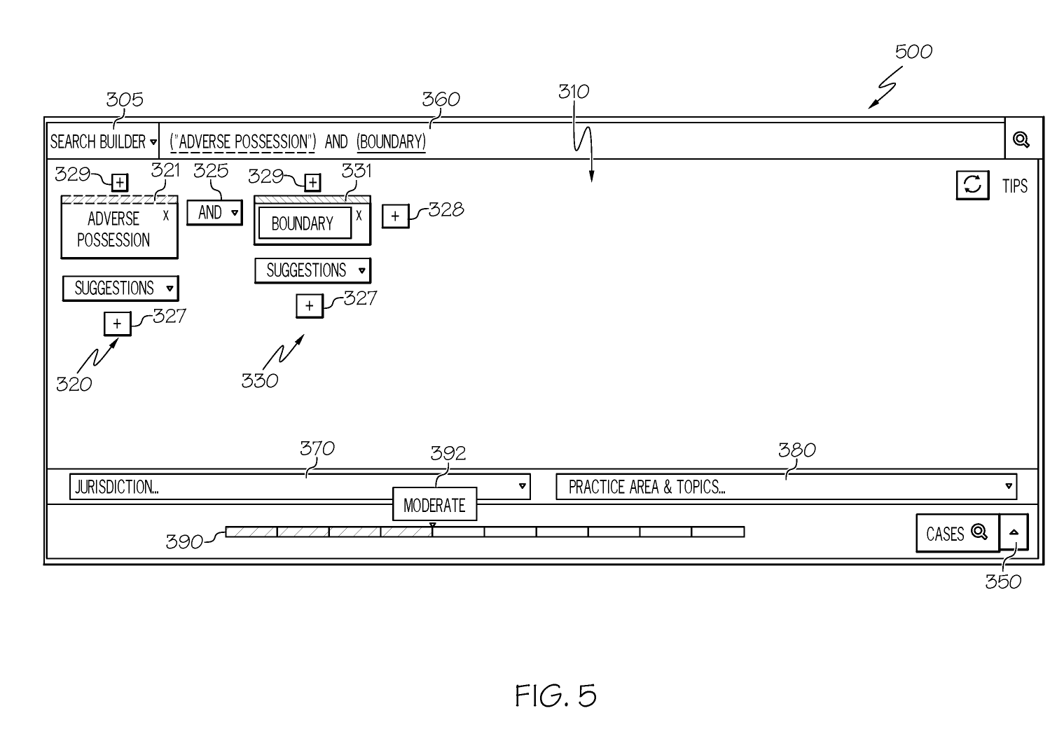

A user may then provide input indicative of a desire to add a concept stack to the query building canvas 310. For example, the user may manipulate the add concept stack element 328. In response to receiving an indication that the user manipulated the add concept stack element 328, the server computing device 12b may provide for display a second concept stack 330 that includes a second concept node 331, as shown in FIG. 5. The server computing device 12b may also provide for display a first connector node 325 adjacent to the first concept stack 320. In the embodiment depicted in FIG. 5, the first connector node 325 is horizontally adjacent to the first concept stack 320 and horizontally adjacent to the second concept stack 330 such that the first connector node 325 is horizontally disposed between the first concept stack 320 and the second concept stack 330. However, in some embodiments, such as embodiments in which concept nodes are horizontally stacked in concept stacks, the first connector node 325 may be vertically adjacent to the first concept stack 320 and vertically adjacent to the second concept stack 330 such that the first connector node 325 is vertically disposed between the first concept stack 320 and the second concept stack 330. In some embodiments, the first connector node 325 is provided for display before the second concept node 331 of the second concept stack 330, such as in embodiments that display the first connector node 325, receive user input indicative of a conjunctive proximity connector for connecting the first query expression associated with the first concept stack 320 with the second query expression associated with the second concept stack 330, and then display the second concept stack 330 with the second concept node 331.

Still referring to the first connector node 325 of FIG. 5, the first connector node 325 is indicative of a conjunctive proximity connector that connects the first query expression associated with the first concept stack 320 with the second query expression associated with the second concept stack 330. The conjunctive proximity connector represents a proximity relationship required between the first query expression and the second query expression in a given document in order for the document to be identified as satisfying the search query. Example conjunctive proximity connectors include “and” (requiring that the first query expression and the second query expression occur in a particular document in order for the document to satisfy the search query), “and not” (requiring that the first query expression occurs in a particular document, but that the second query expression does not occur in the document in order for the document to satisfy the search query), “paragraph” (requiring that the first query expression and the second query expression occur in the same paragraph of a particular document in order for the document to satisfy the search query), “sentence” (requiring that the first query expression and the second query expression occur in the same sentence of a particular document in order for the document to satisfy the search query), “2 words” (requiring that the first query expression and the second query expression occur within 2 words in a particular document in order for the document to satisfy the search query), “3 words” (requiring that the first query expression and the second query expression occur within 3 words in a particular document in order for the document to satisfy the search query), “5 words” (requiring that the first query expression and the second query expression occur within 5 words in a particular document in order for the document to satisfy the search query), “10 words” (requiring that the first query expression and the second query expression occur within 10 words in a particular document in order for the document to satisfy the search query), “20 words” (requiring that the first query expression and the second query expression occur within 20 words in a particular document in order for the document to satisfy the search query), “30 words” (requiring that the first query expression and the second query expression occur within 30 words in a particular document in order for the document to satisfy the search query), or the like. Of course, other conjunctive proximity connectors are possible.

The user may provide input indicative of a conjunctive proximity connector for connecting the first query expression associated with the first concept stack 320 (i.e., the query expression of “adverse possession” in the embodiment depicted in FIG. 5) with a second query expression associated with the second concept stack 330. For example, in some embodiments, in response to user manipulation of the first connector node 325 (e.g., clicking or otherwise selecting the first connector node 325), a drop down list of conjunctive proximity connectors (i.e., “and”, “and not”, “paragraph”, “sentence”, “2 words”, “3 words”, “5 words”, “10 words”, “20 words”, “30 words”, or the like) may be provided for display by the server computing device 12b and displayed by the user computing device 12a. The server computing device 12b may receive user input indicative of a selected conjunctive proximity connector for connecting the first query expression associated with the first concept stack with the second query expression associated with the second concept stack. In response to receiving the user input indicative of the selected conjunctive proximity connector, the server computing device 12b may provide for display the first connector node 325 to include a graphical indication of the selected conjunctive proximity connector. For example, in FIG. 5, user input indicative of selecting the “and” conjunctive proximity connector may be received by the server computing device 12b and the server computing device 12b may provide for display the text “and” within the first connector node 325 as the graphical indication of the “and” conjunctive proximity connector.

A user may provide a second user input indicative of a second query term to be associated with the second concept node 331 of the second concept stack 330. In the embodiment depicted in FIG. 5, the user provides the query term “boundary” as the second user input. The input may be provided by the user via any input device, such as by a keyboard attached to the user computing device 12a, a touchscreen of the user computing device 12a, a microphone of the user computing device 12a, or the like. The server computing device 12b receives the second user input indicative of the second query term. In response to receiving the second user input indicative of the second query term, the server computing device 12b provides for display the second concept node 331 in the query building canvas 310 such that the second concept node 331 includes a graphical indication of the second query term. In the embodiment depicted in FIG. 5, the graphical indication of the second query term is the text “boundary” though in other embodiments a graphical indication other than the text of the second query term may be displayed. In some embodiments, the second concept node 331 may not be displayed until after receiving the user input indicative of the second query term to be associated with the second concept node, such as embodiments in which a user may input the second query term via voice and the server computing device 12b may provide for display the second concept node 331 including the graphical indication of the second query term after receiving the voice input.

In response to receiving the second user input indicative of the second query term and the user input indicative of the “and” conjunctive proximity connector to connect the first query expression and the second query expression, the server computing device 12b generates a search query that includes the first query expression “adverse possession” and the second query expression “boundary” (i.e. (“adverse possession”) AND (boundary)) with the input processing logic 45 and then searches the database using the search query to identify a result set of documents based on the search query. The server computing device 12b may use the search logic 44 to search the document database 38a to identify a result set of document that are identified based on the search query in the manner described above. The server computing device 12b uses the query feedback score calculation logic 46 to calculate a query feedback score for the result set of documents in the manner described above. In the embodiment depicted in FIG. 5, the server computing device 12b provides for display the query feedback indicator 390 based on the calculated query feedback score. The query feedback indicator 390 depicted in FIG. 5 includes a textual indication 392 of “moderate” indicating that the breadth of the search query is moderate based on the number of documents that were identified by the search. The server computing device 12b also provides for display a textual representation of the search query in the textual query translation portion 360, which is displayed by a display device of the user computing device 12a.

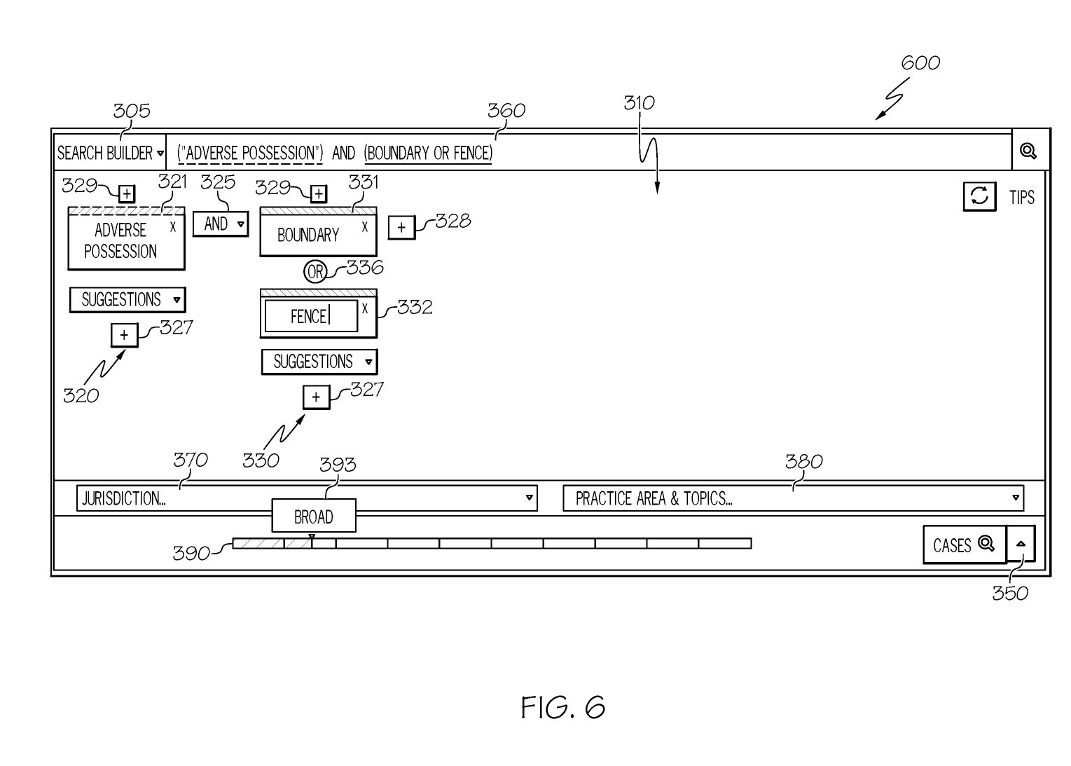

A user may then provide input indicative of a desire to connect with a Boolean OR another query term to the second query term of the second query expression associated with the second concept stack 330 by adding a new concept node to the second concept stack 330. For example, the user may manipulate the add concept node element 327 at the bottom of the second concept stack 330. In response to receiving an indication that the user manipulated the add concept node element 327, the server computing device 12b may provide for display a third concept node 332, as shown in FIG. 6. In some embodiments, the server computing device 12b may also provide for display a first OR connector node 336 disposed between the second concept node 331 and the third concept node 332 to indicate that the query terms associated with the second concept node 331 and the third concept node 332 are connected with a Boolean OR in the second query expression associated with the second concept stack 330. As shown in FIG. 6, the second concept node 331 and the third concept node 332 are stacked relative to one another in the second concept stack 330. In the embodiment depicted in FIG. 6, the second concept node 331 and the third concept node 332 are vertically stacked relative to one another in the second concept stack 330 and the first OR connector node 336 is vertically disposed between the second concept node 331 and the third concept node 332. However, in some embodiments, such as embodiments in which concept stacks are vertically adjacent to one another instead of horizontally adjacent to one another, the second concept node 331 and the third concept node 332 may be horizontally stacked relative to one another in the second concept stack 330 and the first OR connector node 336 may be horizontally disposed between the second concept node 331 and the third concept node 332.

A user may provide a third user input indicative of a third query term to be associated with the third concept node 332 of the second concept stack 330. In the embodiment depicted in FIG. 6, the user provides the query term “fence” as the third user input. The input may be provided by the user via any input device, such as by a keyboard attached to the user computing device 12a, a touchscreen of the user computing device 12a, a microphone of the user computing device 12a, or the like. The server computing device 12b receives the third user input indicative of the third query term. In response to receiving the third user input indicative of the third query term, the server computing device 12b provides for display the third concept node 332 in the query building canvas 310 such that the third concept node 332 includes a graphical indication of the third query term. In the embodiment depicted in FIG. 6, the graphical indication of the third query term is the text “fence” though in other embodiments a graphical indication other than the text of the third query term may be displayed. In some embodiments, the third concept node 332 may not be displayed until after receiving the user input indicative of the third query term to be associated with the third concept node 332, such as embodiments in which a user may input the third query term via voice and the server computing device 12b may provide for display the third concept node 332 including the graphical indication of the third query term after receiving the voice input

In response to receiving the third user input indicative of the third query term, the server computing device 12b may utilize the input processing logic 45 to form the second query expression associated with the second concept stack 330 to be the second query term connected to the third query term with a Boolean OR (i.e. based on the user input depicted in FIG. 6, the second query expression would be (boundary OR fence). In response to receiving the user input indicative of the third query term, the server computing device 12b generates a search query that includes the first query expression “adverse possession” and the second query expression “boundary” OR “fence” (i.e. (“adverse possession”) AND (boundary OR fence)) with the input processing logic 45 and then searches the database using the search query to identify a result set of documents based on the search query. The server computing device 12b may use the search logic 44 to search the document database 38a to identify a result set of document that are identified based on the search query in the manner described above. The server computing device 12b uses the query feedback score calculation logic 46 to calculate a query feedback score for the result set of documents in the manner described above. In the embodiment depicted in FIG. 6, the server computing device 12b provides for display the query feedback indicator 390 based on the calculated query feedback score. The query feedback indicator 390 depicted in FIG. 6 includes a textual indication 393 of “broad” indicating that the search query was likely broad based on the number of documents that were identified by the search. The server computing device 12b also provides for display a textual representation of the search query in the textual query translation portion 360, which is displayed by a display device of the user computing device 12a. The textual indication that the search query is “broad” indicates that the user may wish to further restrict the search query before inspecting the result set of documents so that the result set of documents will likely be more relevant and helpful to the user.

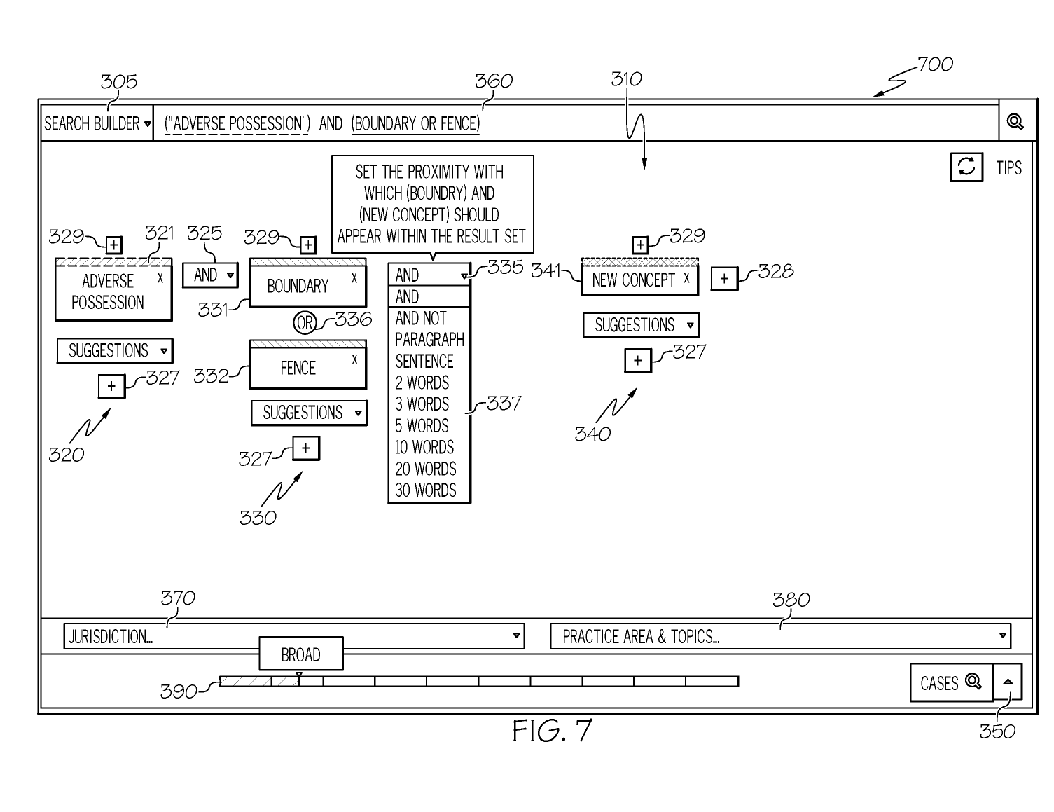

A user may then provide input indicative of a desire to add another concept stack to the query building canvas 310. For example, referring to FIG. 6, the user may manipulate the add concept stack element 328 positioned to the right of the second concept stack 330. In response to receiving an indication that the user manipulated the add concept stack element 328, the server computing device 12b may provide for display a third concept stack 340 that includes a fourth concept node 341, as shown in FIG. 7. The server computing device 12b may also provide for display a second connector node 335 adjacent to the second concept stack 330. In the embodiment depicted in FIG. 7, the second connector node 335 is horizontally adjacent to the second concept stack 330 and horizontally adjacent to the third concept stack 340 such that the second connector node 335 is horizontally disposed between the second concept stack 330 and the third concept stack 340. However, in some embodiments, such as embodiments in which concept nodes are horizontally stacked in concept stacks, the second connector node 335 may be vertically adjacent to the second concept stack 330 and vertically adjacent to the third concept stack 340 such that the second connector node 335 is vertically disposed between the second concept stack 330 and the third concept stack 340. In some embodiments, the second connector node 335 is provided for display before the fourth concept node 341 of the third concept stack 340, such as in embodiments that display the second connector node 335, receive user input indicative of a conjunctive proximity connector for connecting the second query expression associated with the second concept stack 330 with the third query expression associated with the third concept stack 340, and then display the third concept stack 340 with the fourth concept node 341.

Still referring to the second connector node 335 of FIG. 7, the second connector node 335 is indicative of a second conjunctive proximity connector that connects the second query expression associated with the second concept stack 330 with the third query expression associated with the third concept stack 340. The second conjunctive proximity connector represents a proximity relationship required between the second query expression and the third query expression in a given document in order for the document to be identified as satisfying the search query. Example second conjunctive proximity connectors include “and” (requiring that the second query expression and the third query expression occur in a particular document in order for the document to satisfy the search query), “and not” (requiring that the second query expression occurs in a particular document, but that the third query expression does not occur in the document in order for the document to satisfy the search query), “paragraph” (requiring that the second query expression and the third query expression occur in the same paragraph of a particular document in order for the document to satisfy the search query), “sentence” (requiring that the second query expression and the third query expression occur in the same sentence of a particular document in order for the document to satisfy the search query), “2 words” (requiring that the second query expression and the third query expression occur within 2 words in a particular document in order for the document to satisfy the search query), “3 words” (requiring that the second query expression and the third query expression occur within 3 words in a particular document in order for the document to satisfy the search query), “5 words” (requiring that the second query expression and the third query expression occur within 5 words in a particular document in order for the document to satisfy the search query), “10 words” (requiring that the second query expression and the third query expression occur within 10 words in a particular document in order for the document to satisfy the search query), “20 words” (requiring that the second query expression and the third query expression occur within 20 words in a particular document in order for the document to satisfy the search query), “30 words” (requiring that the second query expression and the third query expression occur within 30 words in a particular document in order for the document to satisfy the search query), or the like. Of course, other conjunctive proximity connectors are possible.

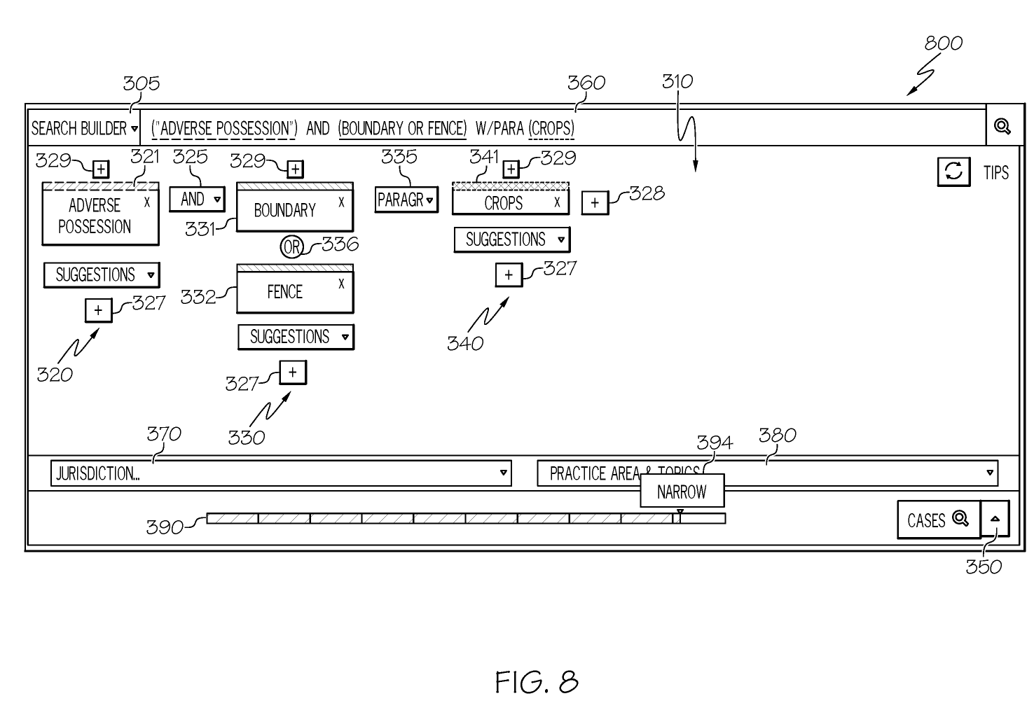

The user may provide input indicative of a second conjunctive proximity connector for connecting the second query expression associated with the second concept stack 330 (i.e., the query expression of (boundary OR fence) in the embodiment depicted in FIG. 7) with a third query expression associated with the third concept stack 340. For example, as shown in FIG. 7, in response to user manipulation of the second connector node 335 (e.g., clicking or otherwise selecting the second connector node 335), a drop down list of conjunctive proximity connectors (i.e., “and”, “and not”, “paragraph”, “sentence”, “2 words”, “3 words”, “5 words”, “10 words”, “20 words”, and “30 words”) is provided for display by the server computing device 12b and displayed by the user computing device 12a. The server computing device 12b receives user input indicative of the selected second conjunctive proximity connector (paragraph is selected as the second conjunctive proximity connector in the embodiment depicted in FIGS. 7-8) for connecting the second query expression associated with the second concept stack 330 with the third query expression associated with the third concept stack 340. In response to receiving the user input indicative of the selected second conjunctive proximity connector, the server computing device 12b may provide for display the second connector node 335 to include a graphical indication of the selected conjunctive proximity connector. For example, in FIG. 8, user input indicative of selecting the “paragraph” conjunctive proximity connector may be received by the server computing device 12b and the server computing device 12b may provide for display the text “paragraph” within the second connector node 335 as the graphical indication of the “paragraph” conjunctive proximity connector.

A user may provide a fourth user input indicative of a fourth query term to be associated with the fourth concept node 341 of the third concept stack 340. In the embodiment depicted in FIG. 8, the user provides the query term “crops” as the fourth user input. The input may be provided by the user via any input device, such as by a keyboard attached to the user computing device 12a, a touchscreen of the user computing device 12a, a microphone of the user computing device 12a, or the like. The server computing device 12b receives the fourth user input indicative of the fourth query term. In response to receiving the fourth user input indicative of the fourth query term, the server computing device 12b provides for display the fourth concept node 341 in the query building canvas 310 such that the fourth concept node 341 includes a graphical indication of the fourth query term. In the embodiment depicted in FIG. 8, the graphical indication of the fourth query term is the text “crops” though in other embodiments a graphical indication other than the text of the fourth query term may be displayed. In some embodiments, the fourth concept node 341 may not be displayed until after receiving the user input indicative of the fourth query term to be associated with the fourth concept node, such as embodiments in which a user may input the fourth query term via voice and the server computing device 12b may provide for display the fourth concept node 341 including the graphical indication of the fourth query term after receiving the voice input.

In response to receiving the second user input indicative of the fourth query term and the user input indicative of the “paragraph” second conjunctive proximity connector to connect the second query expression and the third query expression, the server computing device 12b generates a search query that includes the first query expression “adverse possession” connected to the second query expression (boundary OR fence) with an “and” conjunctive proximity connector, and includes a third query expression “crops” connected to the second query expression with a “paragraph” conjunctive proximity connector (i.e. the search query is: (“adverse possession”) AND (boundary OR fence) w/para crops) with the input processing logic 45 and then searches the database using the search query to identify a result set of documents based on the search query. The server computing device 12b may use the search logic 44 to search the document database 38a to identify a result set of document that are identified based on the search query in the manner described above. The server computing device 12b uses the query feedback score calculation logic 46 to calculate a query feedback score for the result set of documents in the manner described above. In the embodiment depicted in FIG. 8, the server computing device 12b provides for display the query feedback indicator 390 based on the calculated query feedback score. The query feedback indicator 390 depicted in FIG. 8 includes a textual indication 394 of “narrow” indicating that the breadth of the search query is determined to be narrow based on the number of documents that were identified by the search. The server computing device 12b also provides for display a textual representation of the search query in the textual query translation portion 360, which is displayed by a display device of the user computing device 12a.

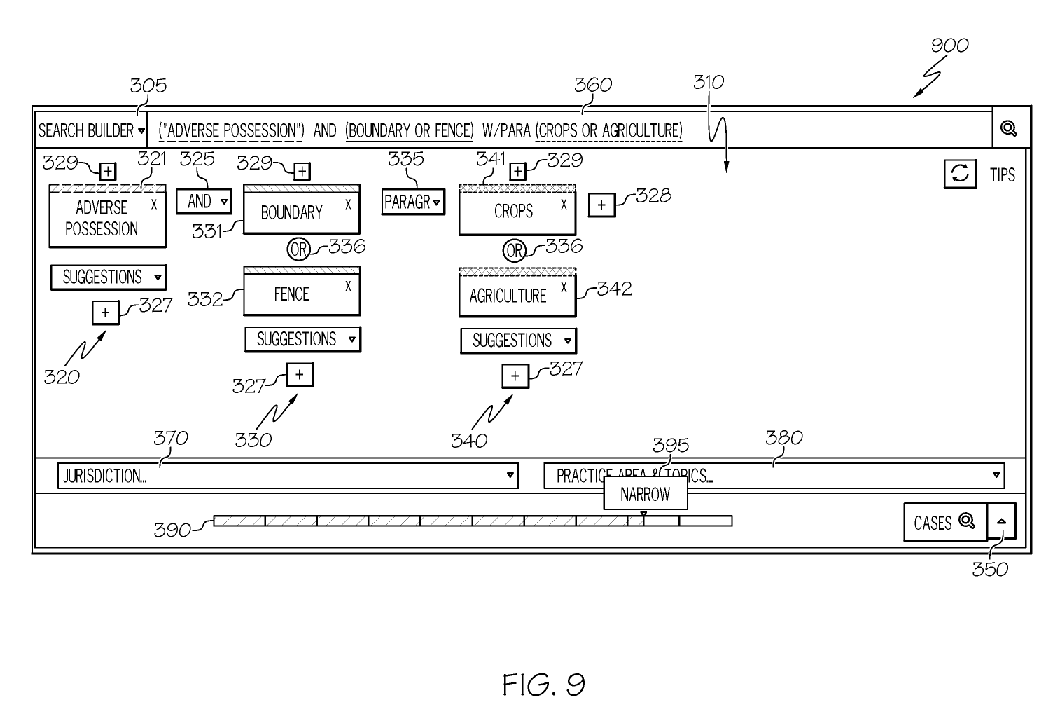

A user may then provide input indicative of a desire to connect with a Boolean OR another query term to the fourth query term of the third query expression associated with the third concept stack 340 by adding a new concept node to the third concept stack 340. For example, the user may manipulate the add concept node element 327 at the bottom of the third concept stack 340. In response to receiving an indication that the user manipulated the add concept node element 327, the server computing device 12b may provide for display a fifth concept node 342, as shown in FIG. 9. In some embodiments, the server computing device 12b may also provide for display a second OR connector node 346 disposed between the fourth concept node 341 and the fifth concept node 342 to indicate that the query terms associated with the fourth concept node 341 and the fifth concept node 342 are connected with a Boolean OR in the third query expression associated with the third concept stack 340. As shown in FIG. 9, the fourth concept node 341 and the fifth concept node 342 are stacked relative to one another in the third concept stack 340. In the embodiment depicted in FIG. 9, the fourth concept node 341 and the fifth concept node 342 are vertically stacked relative to one another in the third concept stack 340 and the second OR connector node 346 is vertically disposed between the fourth concept node 341 and the fifth concept node 342. However, in some embodiments, such as embodiments in which concept stacks are vertically adjacent to one another instead of horizontally adjacent to one another, the fourth concept node 341 and the fifth concept node 342 may be horizontally stacked relative to one another in the third concept stack 340 and the second OR connector node 346 may be horizontally disposed between the fourth concept node 341 and the fifth concept node 342.

A user may provide a fifth user input indicative of a fifth query term to be associated with the fifth concept node 342 of the third concept stack 340. In the embodiment depicted in FIG. 9, the user provides the query term “agriculture” as the fifth user input. The input may be provided by the user via any input device, such as by a keyboard attached to the user computing device 12a, a touchscreen of the user computing device 12a, a microphone of the user computing device 12a, or the like. The server computing device 12b receives the fifth user input indicative of the fifth query term. In response to receiving the fifth user input indicative of the fifth query term, the server computing device 12b provides for display the fifth concept node 342 in the query building canvas 310 such that the fifth concept node 342 includes a graphical indication of the fifth query term. In the embodiment depicted in FIG. 9, the graphical indication of the fifth query term is the text “agriculture” though in other embodiments a graphical indication other than the text of the fifth query term may be displayed. In some embodiments, the fifth concept node 342 may not be displayed until after receiving the user input indicative of the fifth query term to be associated with the fifth concept node 342, such as embodiments in which a user may input the fifth query term via voice and the server computing device 12b may provide for display the fifth concept node 342 including the graphical indication of the fifth query term after receiving the voice input

In response to receiving the fifth user input indicative of the fifth query term, the server computing device 12b may utilize the input processing logic 45 to form the third query expression associated with the third concept stack 340 to be the fourth query term connected to the fifth query term with a Boolean OR (i.e. based on the user input depicted in FIG. 9, the third query expression would be (crops OR agriculture). In response to receiving the user input indicative of the fifth query term, the server computing device 12b generates a search query that includes the first query expression “adverse possession” connected to the second query expression (boundary OR fence) with an “and” conjunctive proximity connector, and includes a third query expression (crops OR agriculture) connected to the second query expression with a “paragraph” conjunctive proximity connector (i.e. the search query is: (“adverse possession”) AND (boundary OR fence) w/para (crops OR agriculture)) with the input processing logic 45 and then searches the database using the search query to identify a result set of documents based on the search query. The server computing device 12b may use the search logic 44 to search the document database 38a to identify a result set of document that are identified based on the search query in the manner described above. The server computing device 12b uses the query feedback score calculation logic 46 to calculate a query feedback score for the result set of documents in the manner described above. In the embodiment depicted in FIG. 9, the server computing device 12b provides for display the query feedback indicator 390 based on the calculated query feedback score. The query feedback indicator 390 depicted in FIG. 9 includes a textual indication 395 of “narrow” indicating that the search query was likely narrow based on the number of documents that were identified by the search. The server computing device 12b also provides for display a textual representation of the search query in the textual query translation portion 360, which is displayed by a display device of the user computing device 12a.

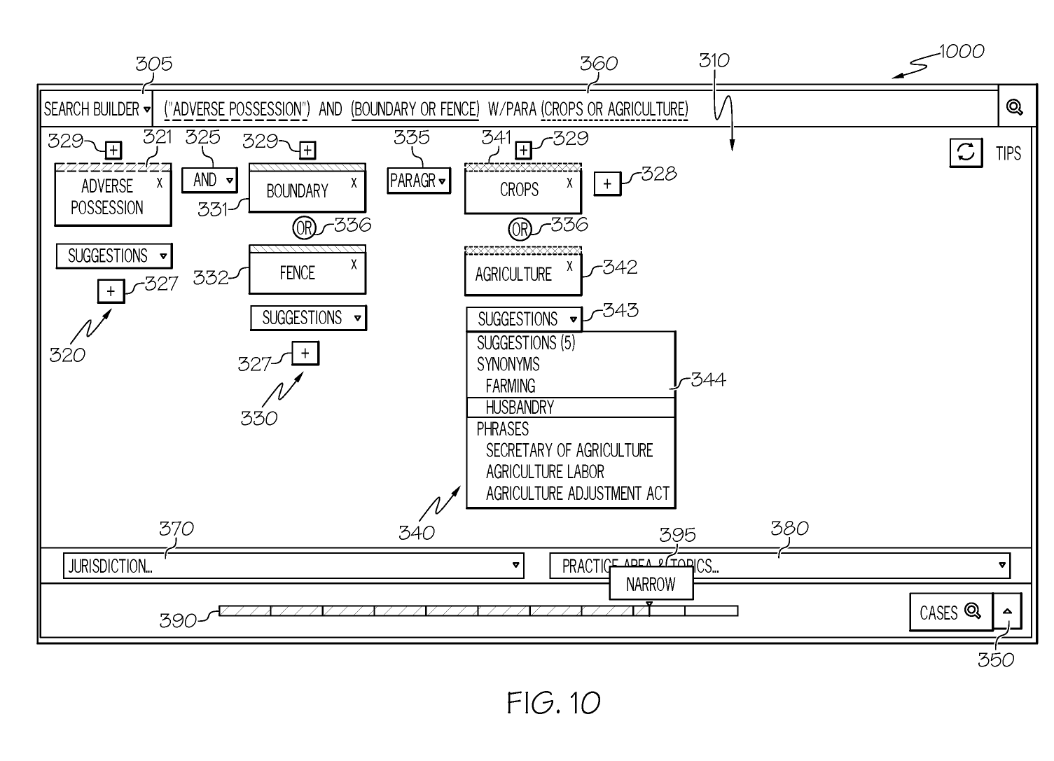

Referring now to FIG. 10, the server computing device 12b may provide suggested query terms in response to user manipulation of a query term suggestion element. For example, a query term suggestion element 343 is provided for display. In response to receiving user input indicative of a selection of the query term suggestion element 343, a query term suggestion drop box 344 may be provided for display by the server computing device 12b. The query term suggestion drop box 344 may include one or more suggested query terms that are determined by the server computing device 12b. The suggested query terms may be determined based on a selected query term (i.e., by receiving user input indicative of a selection of one of the concept nodes and receiving user input indicative of a selection of the query term suggestion element 343). For example, in the embodiment depicted in FIG. 10, user input indicating that the user selected the fifth concept node 342 may be received. In response to receiving the user input indicative of the selection of the fifth concept node 342, the server computing device 12b may generate suggested query terms based on the query term “agriculture” associated with the fifth concept node 342. The suggested query terms may include synonyms of the query term “agriculture”, a wildcard version of the query term “agriculture”, or a variant of the query term “agriculture.” In some embodiments, one or more of the suggested query terms may include a co-occurring query term that co-occurred in a prior search query that included both the co-occurring query term and the query term associated with the selected concept node. In some embodiments, the suggested query terms may be determined based on one or more query terms associated with concept nodes of a concept stack that includes the query term suggestion element without requiring the user to select a particular concept node of the concept stack.

Still referring to FIG. 10, after generating the suggested query terms, the server computing device 12b may provide for display the suggested query terms in the query term suggestion drop box 344. A user may then select one of the suggested query terms. In response to receiving a user selection of one of the suggested query terms, the server computing device 12b may join the selected suggested query term with a Boolean OR to the other query terms of a query expression associated with the concept stack associated with the query term suggestion element. The server computing device 12b may then provide for display an additional concept node in the query stack that includes a graphical indication of the selected suggested query term. The server computing device 12b may then search the documents in the manner described above based on the modified query. For example, if a user selected the suggested query term “husbandry” as shown in FIG. 10, a sixth concept node would be added to the third concept stack 340, beneath the fifth concept node 342, which would include a graphical indication of the query term “husbandry.”. Then, the server computing device 12b may utilize the input processing logic 45 to update the third query expression associated with the third concept stack 340 to be the fourth query term, the fifth query term, and the “husbandry” query term, all connected with a Boolean OR (i.e. the updated third query expression would be (crops OR agriculture OR husbandry). The server computing device 12b would then generate a search query that includes the first query expression “adverse possession” connected to the second query expression (boundary OR fence) with an “and” conjunctive proximity connector, and includes the updated third query expression (crops OR agriculture OR husbandry) connected to the second query expression with a “paragraph” conjunctive proximity connector (i.e. the updated search query would be: (“adverse possession”) AND (boundary OR fence) w/para (crops OR agriculture OR husbandry)) with the input processing logic 45 and then search the database using the search query to identify a result set of documents based on the search query, calculate an updated query feedback score for the result set of documents, provide for display an updated query feedback indicator, and provide for display a textual representation of the search query in the textual query translation portion 360 in the manner described above.

In some embodiments, the concept nodes of the concept stacks are color coded. For example, the first concept node 321 of the first concept stack 320 may be color coded to include a first color (e.g., blue), the second concept node 331 and the third concept node 332 of the second concept stack 330 may be color coded to include a second color that is different than the first color (e.g., red) but not include the first color, and the fourth concept node 341 and the fifth concept node 342 of the third concept stack 340 may be color coded to include a third color that is different than the first color and the second color (e.g., green) but that does not include the first color and the second color. Some embodiments do not include color coded concept stacks.

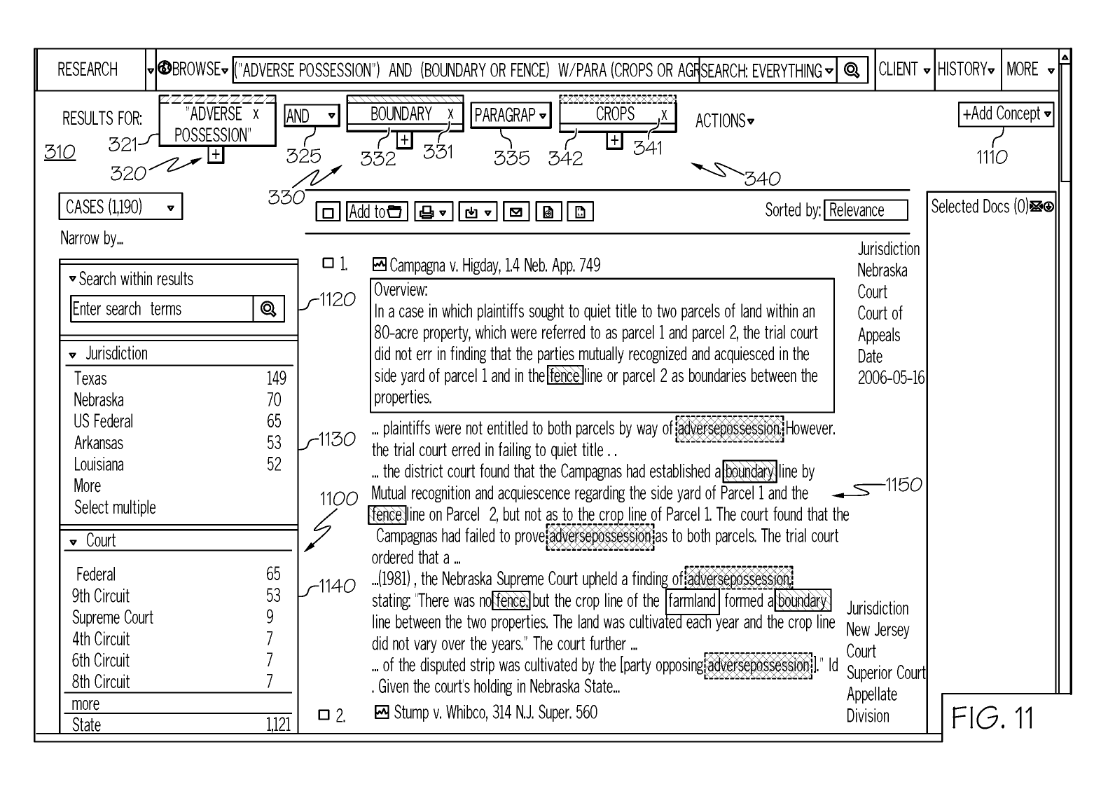

Referring now to FIG. 11, a graphical user interface 1100 including the query building canvas 310, an add concept element 1110, a search within results element 1120, a jurisdiction filter element 1130, a court filter element 1140, and a results portion 1150 is schematically depicted. The graphical user interface 1100 and the components thereof may be provided for display by the server computing device 12b and displayed by the user computing device 12a, for example in response to a user request to view the results (e.g., by clicking on or otherwise manipulating the left side of the content type selection element 350 of FIG. 10). The results portion 1150 displays a portion of two of the documents in the result set of documents, allowing a user to quickly and efficiently review the documents to determine if they are relevant to the user's query. In other embodiments, more or fewer documents may be displayed in the results portion 1150. In some embodiments, only the names of documents may be displayed. The add concept element 1110 may allow a user to add a concept to one or more of the concept stacks of the query building canvas 310 as will be described below. The search within results element 1120 allows a user to search within the result set of documents to narrows the results to only those that match a further search query entered into the search within results element 1120. The jurisdiction filter element 1130 allows a user to filter the result set of documents to only those that match a particular jurisdiction selected from the plurality of jurisdictions displayed in the jurisdiction filter element 1130. Likewise, the court filter element 1140 allows a user to filter the result set of documents to only those that match a particular court selected from the plurality of courts displayed in the court filter element 1140. As shown in FIG. 11, the query building canvas 310 is compressed such that the concept stacks are “rolled up” to occupy only a thin row above the results portion 1150. In the embodiment depicted in FIG. 11, the top concept node of each concept stack is fully displayed, but additional concept nodes of the concept stacks are partially obstructed such that each concept stacks appears to be a stack of cards with only portions of cards below the top concept stack protruding. Some embodiments may fully display the concept nodes in the query building canvas 310.

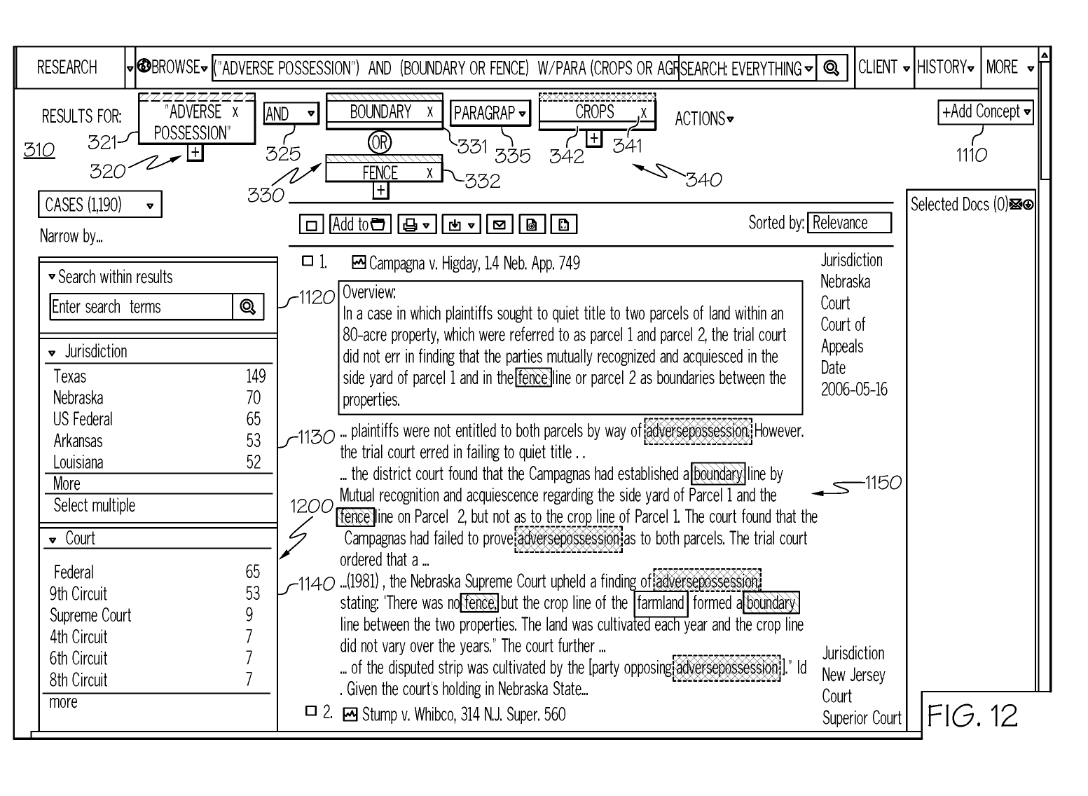

Referring now to FIG. 12, in some embodiments in which the concepts stacks are compressed to appear as stacks of cards, hovering over or otherwise manipulating or selecting a particular concept stack causes the server computing device 12b to provide for display all of the nodes of the selected concept stack without obstruction. For example, as shown in FIG. 12, in response to receiving input indicative of a user hovering a mouse over the second concept stack 330, the server computing device 12b provides for display an updated graphical user interface that expands the previously compressed second concept stack 330 into an uncompress second concept stack 330 in which the second concept node 331 and the third concept node 332 are fully visible. In some embodiments, hovering over or otherwise manipulating any of the concept nodes or concept stacks in the query building canvas 310 causes the server computing device 12b to provide for display all of the concept nodes of all of the concept stacks without obstruction. Still referring to FIG. 12, query terms associated with the concept nodes of the concept stacks may be highlighted in the results portion. For example, the query term “fence” associated with the third concept node 332 is highlighted in the displayed text of the documents in the results portion 1150. Similarly, the query term “boundary” associated with the second concept node 331 is highlighted in the displayed text of the documents in the results portion 1150. In some embodiments, query terms associated with the concept nodes of the concept stacks may be color-coded to correspond to the color of the concept stack. For example, the query terms “fence” and “boundary,” which are associated with concept nodes of the second concept stack may be color coded with the same color as the second concept stack. Similarly, any query terms associated with the concept nodes of the first concept stack may be color coded with the color associated with the first concept stack, and any query terms associated with the concept nodes of the third concept stack may be color coded with the color associated with the third concept stack. By color coding the query terms in the results accordingly, a user may be able to easily and efficiently understand the relative occurrence and concentration of query terms among different concept stacks.

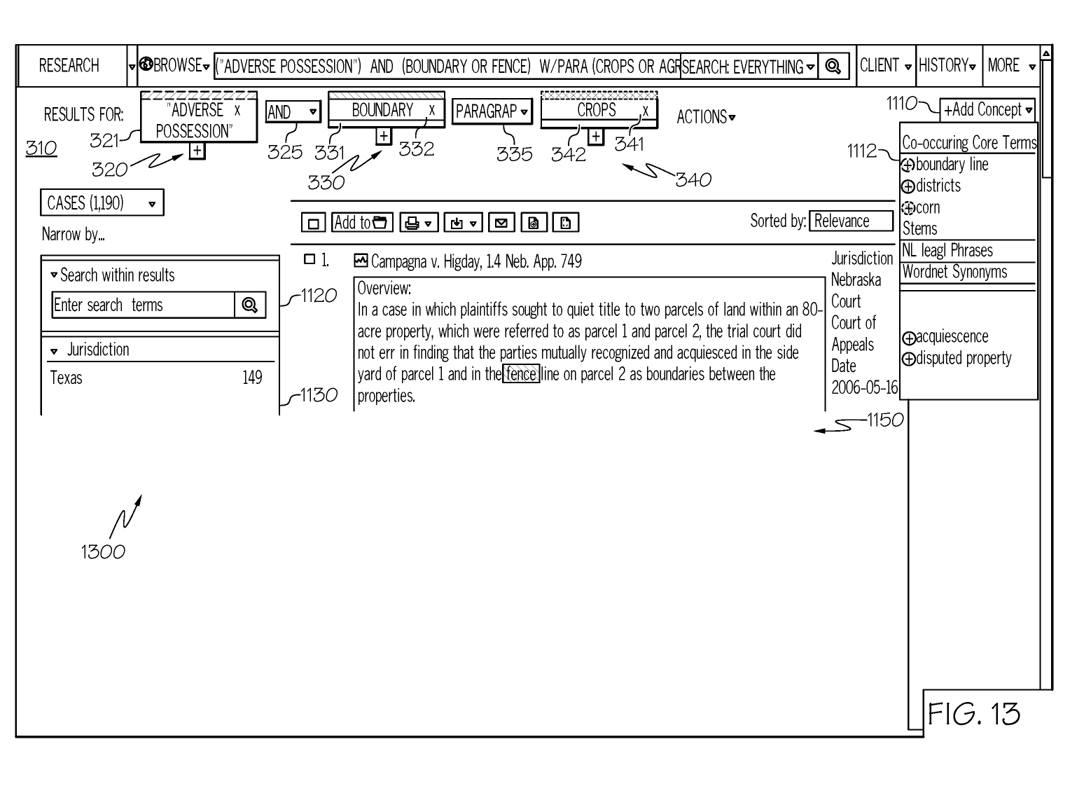

Referring now to FIG. 13, some embodiments may allow a user to add a concept to one or more of the concept stacks of the query building canvas 310 by manipulating the add concept element 1110. For example, in response to receiving user input indicative of a selection of the add concept element 1110 (e.g., by receiving a message indicating that the user clicked on or otherwise selected the add concept element 1110), the server computing device 12b may provide for display a concept drop box 1112 including a list of concepts that may be added to the query. The list of concepts may be generated by the server computing device 12b in a variety of manners, such as by analyzing the search query constructed based on the user input provided to generate the concept nodes and concept stacks against a set of core terms that may be automatically created for a particular content type or document in the document database. In some embodiments, the list of concepts may be color coded to indicate concepts suggested for addition to an existing concept stack, such as by color coding a suggested concept with the same color of a color coded concept stack to indicate that the suggested concept is suggested to be added to the concept stack color coded with the same color. In some embodiments, in response to a user selection of one of the concept suggestions, the concept suggestion may be added to an existing concept stack or may be added as a new concept node of a new concept stack. For example, in response to a user manipulating the “boundary line” suggested concept (e.g., by clicking on the “boundary line” suggested concept or dragging the “boundary line” suggested concept proximate the second concept stack 330), the server computing device 12b may join the selected suggested concept with a Boolean OR to the other query terms of the second query expression associated with the second concept stack 330. The server computing device 12b may then provide for display an additional concept node in the second concept stack 330 that includes a graphical indication of the selected suggested concept. The server computing device 12b may then search the documents in the manner described above based on the modified query. For example, if a user selected the suggested concept “boundary line”, an additional concept node would be added to the second concept stack 330, which would include a graphical indication of the query term “boundary line”. Then, the server computing device 12b may utilize the input processing logic 45 to update the second query expression associated with the second concept stack 330 to be (boundary OR fence OR “boundary line”). The server computing device 12b would then generate a search query that includes the first query expression “adverse possession” connected to the second query expression (boundary OR fence OR “boundary line”) with an “and” conjunctive proximity connector, and includes the third query expression (crops OR agriculture) connected to the second query expression with a “paragraph” conjunctive proximity connector (i.e. the updated search query would be: (“adverse possession”) AND (boundary OR fence OR “boundary line”) w/para (crops OR agriculture)) with the input processing logic 45 and then search the database using the search query to identify a result set of documents based on the search query, calculate an updated query feedback score for the result set of documents, provide for display an updated query feedback indicator, and provide for display a textual representation of the search query in the textual query translation portion 360 in the manner described above.

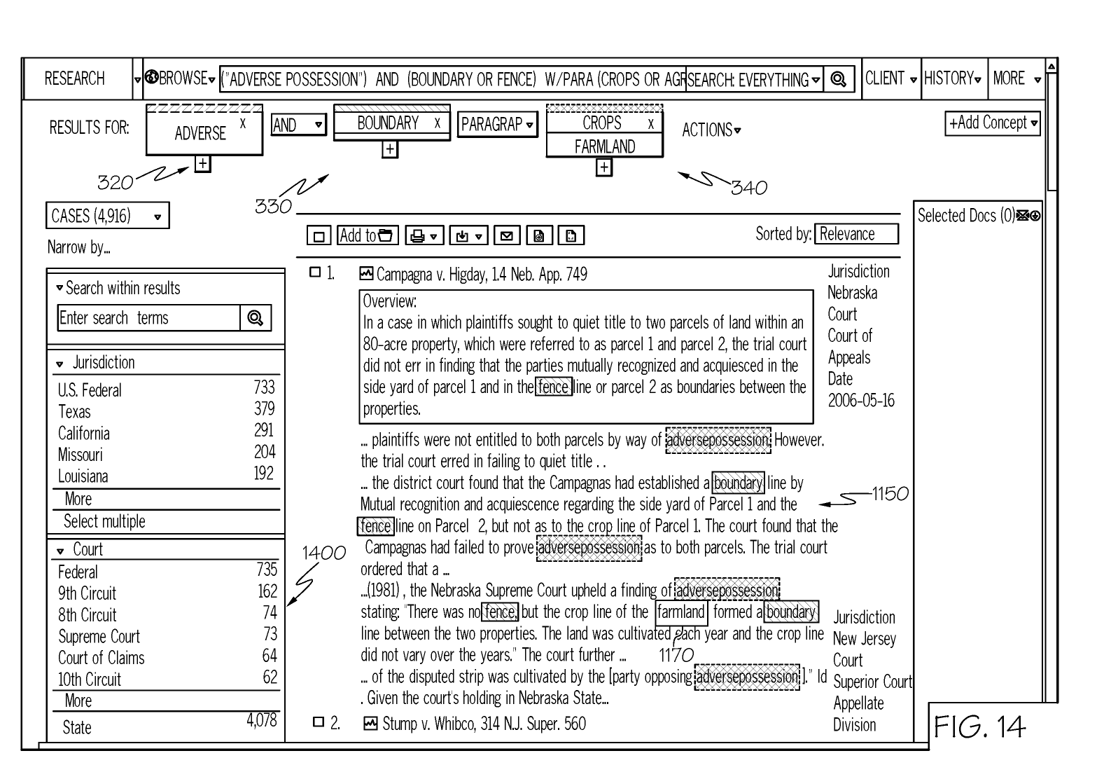

Referring now to FIG. 14, some embodiments may allow a user to add a concept to one or more of the concept stacks of the query building canvas 310 by dragging and dropping a term of a portion of a document displayed in the results portion 1150. For example, in response to receiving user input indicative of dragging and dropping a term 1170 from the results portion 1150 to the third concept stack 340, the server computing device 12b may join the term 1170 with a Boolean OR to the other query terms of the third query expression associated with the third concept stack 340. The server computing device 12b may then provide for display an additional concept node in the third concept stack 340 that includes a graphical indication of the term 1170 (i.e. “farmland” in this example). The server computing device 12b may then search the documents in the manner described above based on the modified query. For example, if a user dragged and dropped the term “farmland” from the results portion 1150 to the third concept stack 340, an additional concept node would be added to the third concept stack 340, which would include a graphical indication of the query term “farmland”. Then, the server computing device 12b may utilize the input processing logic 45 to update the third query expression associated with the third concept stack 340 to be (crops OR agriculture OR farmland). The server computing device 12b would then generate a search query that includes the first query expression “adverse possession” connected to the second query expression (boundary OR fence) with an “and” conjunctive proximity connector, and includes the third query expression (crops OR agriculture OR farmland) connected to the second query expression with a “paragraph” conjunctive proximity connector (i.e. the updated search query would be: (“adverse possession”) AND (boundary OR fence) w/para (crops OR agriculture OR farmland)) with the input processing logic 45 and then search the database using the search query to identify a result set of documents based on the search query, calculate an updated query feedback score for the result set of documents, provide for display an updated query feedback indicator, and provide for display a textual representation of the search query in the textual query translation portion 360 in the manner described above.

Accordingly, it should be understood that embodiments described herein include graphical user interfaces that include concept stacks, which include stacked concept nodes associated with query terms that are joined with Boolean ORs. The concept stacks are connected by conjunctive proximity connectors that join the query expressions associated with each concept stack. The graphical user interfaces described herein may facilitate the generation of search queries by allowing a user to construct the search queries with the query building canvases described herein. The graphical user interfaces described herein may also allow a user to iteratively refine and manipulate search queries by interacting with the graphical user interfaces. The graphical user interfaces described herein may also allows a user to understand the quality of a query and/or the results generated by a query in an intuitive and user-friendly manner such that a user may identify desired content and have confidence that the identified content is relevant.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for searching a database to identify a result set of documents, the method comprising:
providing for display, automatically by a computer, a graphical user interface comprising a query building canvas;
receiving a first user input indicative of a first query term;
providing for display a first concept node in the query building canvas, wherein the first concept node includes a first graphical indication of the first query term;
receiving a second user input indicative of a second query term to be connected with a Boolean OR to the first query term in a first query expression of a search query;
providing for display a second concept node in the query building canvas, wherein the second concept node includes a second graphical indication of the second query term, wherein the first concept node and the second concept node are stacked relative to one another in a first concept stack;
receiving a user input indicative of a conjunctive proximity connector for connecting the first query expression to a second query expression in the search query;
providing for display a connector node in the query building canvas such that the connector node is adjacent to the first concept stack, wherein the connector node includes a graphical indication of the conjunctive proximity connector;
receiving a third user input indicative of a third query term;
providing for display a third concept node in the query building canvas, wherein the third concept node includes a third graphical indication of the third query term, wherein the third concept node is adjacent to the connector node and the connector node is disposed between the third concept node and the first concept stack;
receiving a fourth user input indicative of a fourth query term to be connected with a Boolean OR to the third query term in the second query expression of the search query;
providing for display a fourth concept node in the query building canvas, wherein the fourth concept node includes a fourth graphical indication of the fourth query term, wherein the third concept node and the fourth concept node are stacked relative to one another in a second concept stack;
generating the search query to include the first query expression, the second query expression, and the conjunctive proximity connector, wherein the first query expression includes the first query term connected to the second query term with a Boolean OR, the second query expression includes the third query term connected to the fourth query term with a Boolean OR, and the first query expression and the second query expression are connected by the conjunctive proximity connector; and
searching the database using the search query to identify the result set of documents, wherein the result set of documents are identified based on the search query.

2. The method of claim 1, wherein:
the first concept node and the second concept node are vertically stacked relative to one another in the first concept stack;
the third concept node and the fourth concept node are vertically stacked relative to one another in the second concept stack; and
the connector node is horizontally adjacent to the first concept stack and horizontally adjacent to the second concept stack such that the connector node is horizontally disposed between the first concept stack and the second concept stack.

3. The method of claim 1, wherein:
the first concept node and the second concept node are horizontally stacked relative to one another in the first concept stack;
the third concept node and the fourth concept node are horizontally stacked relative to one another in the second concept stack; and
the connector node is vertically adjacent to the first concept stack and vertically adjacent to the second concept stack such that the connector node is vertically disposed between the first concept stack and the second concept stack.

4. The method of claim 1, further comprising:
providing for display in the graphical user interface a textual representation of the search query, wherein the textual representation of the search query includes the text of the first query term, the text of the second query term, the Boolean OR connecting the first query term and the second query term, the conjunctive proximity connector connecting the first query expression and the second query expression, the text of the third query term, the Boolean OR connecting the third query term and the fourth query term, and the text of the fourth query term.

5. The method of claim 1, further comprising:
calculating a query feedback score based on the result set of documents and the search query; and
providing for display a query feedback indicator based on the query feedback score.

6. The method of claim 1, further comprising:
providing for display a practice area selection element on the graphical user interface;
in response to user manipulation of the practice area selection element, providing for display a plurality of practice area options;
receiving a selected practice area option of the plurality of practice area options; and
searching the database to identify the result set of documents such that each document of the result set of documents is associated with the selected practice area option.

7. The method of claim 1, further comprising:
providing for display a document segment selection element on the graphical user interface;
in response to user manipulation of the document segment selection element, providing for display a plurality of document segment options;
receiving a selected document segment option of the plurality of document segment options; and
searching segments of documents in the database associated with the selected document segment option with the search query.

8. The method of claim 1, further comprising:
providing for display a jurisdiction selection element on the graphical user interface;
in response to user manipulation of the jurisdiction selection element, providing for display a plurality of jurisdiction options;
receiving a selected jurisdiction option of the plurality of jurisdiction options; and
searching the database to identify the result set of documents such that each document of the result set of documents is associated with the selected jurisdiction option.

9. The method of claim 1, further comprising:
providing for display a content type selection element on the graphical user interface;
in response to user manipulation of the content type selection element, providing for display a plurality of content type options;
receiving a selected content type option of the plurality of content type options; and
searching the database to identify the result set of documents such that each document of the result set of documents is associated with the selected content type option.

10. The method of claim 1, further comprising:
receiving user input indicative of a selected concept node of the first concept node, the second concept node, the third concept node, and the fourth concept node; and
providing for display a suggested query term based on a query term associated with the selected concept node.

11. The method of claim 10, wherein the suggested query term includes: a synonym of the query term associated with the selected concept node, a wildcard version of the query term associated with the selected concept node, or a variant of the query term associated with the selected concept node.

12. The method of claim 10, wherein the suggested query term includes a co-occurring query term that co-occurred in a prior search query that included both the co-occurring query term and the query term associated with the selected concept node.

13. A method for searching a database to identify a result set of documents, the method comprising:
providing for display, automatically by a computer, a graphical user interface comprising a query building canvas;
providing for display a first concept node in the query building canvas;
after providing for display the first concept node, receiving a first user input indicative of a first query term to associate with the first concept node;
in response to receiving the first user input, providing for display a first graphical indication of the first query term in the first concept node;
providing for display a second concept node in the query building canvas such that the first concept node and the second concept node are stacked relative to one another in a first concept stack;
after providing for display the second concept node, receiving a second user input indicative of a second query term to be associated with the second concept node and to be connected with a Boolean OR to the first query term in a first query expression of a search query;
in response to receiving the second user input, providing for display a second graphical indication of the second query term in the second concept node;
receiving a user input indicative of a conjunctive proximity connector for connecting the first query expression to a second query expression in the search query;
providing for display a connector node in the query building canvas such that the connector node is adjacent to the first concept stack, wherein the connector node includes a graphical indication of the conjunctive proximity connector;
providing for display a third concept node in the query building canvas such that the third concept node is adjacent to the connector node and the connector node is disposed between the third concept node and the first concept stack;
after providing for display the third concept node, receiving a third user input indicative of a third query term to be associated with the third concept node;
in response to receiving the third user input, providing for display a third graphical indication of the third query term in the third concept node;
providing for display a fourth concept node in the query building canvas such that the third concept node and the fourth concept node are stacked relative to one another in a second concept stack;
after providing for display the fourth concept node, receiving a fourth user input indicative of a fourth query term to be associated with the fourth concept node and to be connected with a Boolean OR to the third query term in the second query expression of the search query;
in response to receiving the fourth user input, providing for display a fourth graphical indication of the fourth query term in the fourth concept node;
generating the search query to include the first query expression, the second query expression, and the conjunctive proximity connector, wherein the first query expression includes the first query term connected to the second query term with a Boolean OR, the second query expression includes the third query term connected to the fourth query term with a Boolean OR, and the first query expression and the second query expression are connected by the conjunctive proximity connector; and
searching the database using the search query to identify the result set of documents, wherein the result set of documents are identified based on the search query.

14. The method of claim 13, wherein:
the first concept node and the second concept node are vertically stacked relative to one another in the first concept stack;
the third concept node and the fourth concept node are vertically stacked relative to one another in the second concept stack; and
the connector node is horizontally adjacent to the first concept stack and horizontally adjacent to the second concept stack such that the connector node is horizontally disposed between the first concept stack and the second concept stack.

15. The method of claim 13, wherein:
the first concept node and the second concept node are horizontally stacked relative to one another in the first concept stack;
the third concept node and the fourth concept node are horizontally stacked relative to one another in the second concept stack; and
the connector node is vertically adjacent to the first concept stack and vertically adjacent to the second concept stack such that the connector node is vertically disposed between the first concept stack and the second concept stack.

16. The method of claim 13, further comprising:
providing for display in the graphical user interface a textual representation of the search query, wherein the textual representation of the search query includes the text of the first query term, the text of the second query term, the Boolean OR connecting the first query term and the second query term, the conjunctive proximity connector connecting the first query expression and the second query expression, the text of the third query term, the Boolean OR connecting the third query term and the fourth query term, and the text of the fourth query term.

17. A method for searching a database to identify a result set of documents, the method comprising:
providing for display, automatically by a computer, a graphical user interface comprising a query building canvas;
receiving user input indicative of: a first plurality of query terms to be connected with Boolean ORs in a first query expression of a search query, a second plurality of query terms to be connected with Boolean ORs in a second query expression of the search query, and a conjunctive proximity connector for connecting the first query expression to the second query expression in the search query;
providing for display a first concept stack in the query building canvas, wherein the first concept stack includes a first plurality of concept nodes stacked relative to on one another, wherein individual concept nodes of the first plurality of concept nodes correspond to individual query terms of the first plurality of query terms, and wherein individual concept nodes of the first plurality of concept nodes include graphical representations of the corresponding individual query terms of the first plurality of query terms;
providing for display a connector node in the query building canvas such that the connector node is adjacent to the first concept stack, wherein the connector node comprises a graphical indication of the conjunctive proximity connector;
providing for display a second concept stack in the query building canvas adjacent to the connector node such that the connector node is disposed between the first concept stack and the second concept stack, wherein the second concept stack includes a second plurality of concept nodes stacked relative to one another, wherein individual concept nodes of the second plurality of concept nodes correspond to individual query terms of the second plurality of query terms, and wherein individual concept nodes of the second plurality of concept nodes include graphical representations of the corresponding individual query terms of the second plurality of query terms;
generating the search query to include the first query expression, the second query expression, and the conjunctive proximity connector, wherein the first query expression includes the first plurality of query terms connected with the Boolean ORs, the second query expression includes the second plurality of query terms connected with the Boolean ORs, and the first query expression and the second query expression are connected by the conjunctive proximity connector; and
searching the database using the search query to identify the result set of documents, wherein the result set of documents are identified based on the search query.

18. The method of claim 17, wherein:
the first plurality of concept nodes are vertically stacked relative to one another in the first concept stack;
the second plurality of concept nodes are vertically stacked relative to one another in the second concept stack; and
the connector node is horizontally adjacent to the first concept stack and horizontally adjacent to the second concept stack such that the connector node is horizontally disposed between the first concept stack and the second concept stack.

19. The method of claim 17, wherein:
the first plurality of concept nodes are horizontally stacked relative to one another in the first concept stack;
the second plurality of concept nodes are horizontally stacked relative to one another in the second concept stack; and
the connector node is vertically adjacent to the first concept stack and vertically adjacent to the second concept stack such that the connector node is vertically disposed between the first concept stack and the second concept stack.

20. The method of claim 17, further comprising:
providing for display in the graphical user interface a textual representation of the search query, wherein the textual representation of the search query includes the text of the first plurality of query terms, the Boolean ORs connecting the first plurality of query terms, the conjunctive proximity connector connecting the first query expression and the second query expression, the text of the second plurality of query terms, and the Boolean ORs connecting the second plurality of query terms.
